(19) United States
(12) Patent Application Publication
(10) Pub. No.: US 2020/0093135 A1
(43) Pub. Date: Mar. 26, 2020

(54) SYSTEMS FOR PEST ELIMINATION, SUPPRESSION OR CONTROL

(71) Applicant: EMEKATECH, LLC, SANTA CLARA, CA (US)

(72) Inventors: Emeka J. NCHEKWUBE, Morgan Hill, CA (US); Cyprian Emeka UZOH, San Jose, CA (US)

(21) Appl. No.: 16/657,887

(22) Filed: Oct. 18, 2019

Related U.S. Application Data
(63) Continuation of application No. 15/119,830, filed on Aug. 18, 2016, now abandoned.
(60) Provisional application No. 61/966,346, filed on Feb. 21, 2014.

(51) Int. Cl. A01N 45/02; A01N 65/40; A01N 65/08; A01N 25/00; A01N 27/00; A01N 31/04; A01N 35/06; A01N 37/02; A01N 37/06; A01N 43/54; A01N 45/00; A01N 61/00

(52) U.S. Cl. CPC A01N 45/02; A01N 65/40; A01N 65/08; A01N 25/00; A01N 27/00; A01N 61/00; A01N 35/06; A01N 37/02; A01N 37/06; A01N 43/54; A01N 45/00; A01N 31/04

(57) ABSTRACT

Provided herein are systems, methods, active ingredients, compositions and formulations for killing, deterring growth, or suppressing a population of certain species of pests such as insects, fungi and bacteria.

This application claims the benefit to U.S. Provisional Application No. 61/966346, filed on Feb. 21, 2014, which is hereby incorporated by reference in its entirety, and Patent Application No. PCT/US2015/016964, filed Feb. 20, 2015, which is hereby incorporated by reference in its entirety.

### INCORPORATION BY REFERENCE

All publications, patents, and patent applications mentioned in this specification are herein incorporated by reference to the same extent as if each individual publication, patent or patent application was specifically and individually indicated to be incorporated by reference. In case of any inconsistency between the incorporated by reference publications and the instant specification, the instant specification will control.

### BACKGROUND

The mushroom pests, which include phorids, cecids, sciarids, mycetophils, scaptosids, house flies, horse flies, mites, spiders, and Verticillium, can reduce the productivity of mushroom farms. The damage mushroom crops at times lead to economic loss to farm owners. Additionally, they may be vectors for mushroom diseases such as fungal infections (e.g. verticillium fungicola), truffle disease, and various viruses and bacteria. Currently, mesh materials with fine aperture is sometimes used to exclude flies from the spawning and mycelium growth phases, however, such attempt is less helpful in confronting major infestation.

In some mushroom factories, Malathion is used outside the mushroom house or indoors when mushrooms are not present. As a result, the use of pesticide requires the regular testing of worker for liver, kidney or blood toxicity from pesticide exposure. Additional precautions that may be used include the use of appropriate attire which is required during pesticide applications, as well as careful record including the formulations used, rated of applications and records of any unusual developments are often required. Another approach is to use burning mosquito coils inside mushroom houses may be used when mushrooms are present. Mushroom pest induced crop failure is a major source of economic loss for the industry and a major nuisance for the surrounding public.

In industrial farming operations, for example in commercial egg production facilities, fly densities may be suppressed by the application of larvacides directly or indirectly to where the flies congregate or their favorite resting locations. However, resistance to permethrin has developed rapidly in fly populations from farms on a continuous permethrin regime. Treating manure with insecticide is highly discouraged as it interferes with biological control of flies and often results in a rebound of the fly population. In some cattle and horse ranches, insecticides (especially insect growth regulators and larvacides) are fed to livestock, and residual insecticide in the manure inhibits fly breeding. Continuous exposure of flies to insecticides has led to the development of insecticide resistance to many insecticides.

The may be a need for a new method or system to effectively suppress or control mushroom pest that poses lesser risk to human life and is environmentally friendly.

### SUMMARY

In one aspect, disclosed herein is a method for reducing the population of at least one insect. The method comprising isolating and purifying at least one active ingredient from at least one part of a pepper plant, a musa plant, a piper plant or a Gongronema plant; forming a formulation by adding the at least one active ingredient to a carrier; and killing the at least one pest when the at least one pest is at least in close proximity with the formulation.

In some embodiments, the insect is selected from the group consisting of cecid fly, mycetophils, nits, hose fly, horse fly, phorid fly, sciarid fly and spider, wherein the insect is an edible mushroom pest, a grape pest or a landfill pest. In some cases, the Cecid fly is Mycophila speyeri or Heteropeza pygmaea. The method further comprising killing the larva of the insect.

In some cases, the formulation is between zero and one ppb of the at least one active ingredient, it is able to reduce the population of at least one pest by at least 90% in less than sixty seconds. In some cases, the formulation is between zero and one ppb of the at least one active ingredient, it is able to reduce the population of at least one pest by at least 90% in less than two seconds.

In some cases, adding the at least one active ingredient to a carrier comprises mixing.

The formulation can further comprises a dye. The dye can be a fluorescent dye.

The pepper can comprise Aframomum melegneta (alligator pepper) plant or a Xylopia aethiopica (uda). In some cases, a catalyst can be added to the formulation or copmosition. In some cases, the catalyst can comprise an inorganic compound. Non-limiting examples of inorganic compounds comprise magnesium oxide, aluminum oxide, titanium oxide, iron oxides, nickel, nickel oxides, calcium oxides, platinum or platinum complexes.

In some embodiments, a dye can be added. The dye can be a fluorescent dye. In some embodiments, an absorbent can be added. In some embodiments, a colloidal material can be added. In some embodiments, a porous material can be added. In some embodiments, a hygroscopic material can be added. In some embodiments, a clay can be added. The day can be bentonite clay or ball clay. In some embodiments, a stone can be added.

The Gongronema can be Gongronema latifolium (Utazi). The Musa can be banana or plantain. The Piper can be Piper capensis (Uzazi).

In some cases, a carrier can comprise an emulsion, a suspension, a paste, a gel, a solid, or a solution. The carrier can be a hydrophilic carrier. The carrier can be a hydrophobic carrier. The carrier can comprise both hydrophobic and hydrophilic materials. The carrier can compose an amphiphilic material. The carrier can comprise a bola-amphiphilic material. The carrier can be aqueous. The carrier can be non-aqueous. The carrier can comprise aqueous and non-aqueous materials. The formulation can be in the form of vapor (e.g. water vapor). The formulation can comprise an absorbent. The formulation can comprise a dye. The formulation can comprise titanium oxide. The formulation can comprise a surfactant. The surfactant can be soap. The formulation may comprise an oil. The oil may be an aromatic oil.

Isolation and purification can comprise extracting by using an organic solvent. Isolation and purification can comprise extracting by using a hydrophilic or a hydrophobic solvent. The isolating and purification can comprise extracting by using an amphiphile. The isolation and purification may comprise high temperature aqueous solution or steam solution. Examples of solvent can be selected from the group consisting of an aliphatic compound, and ester and an alcohol. In some cases, the solvent can be a solvent selected from the group consisting of ethyl acetate, hexane, heptane, dimethylsulfoxide, diethylether, tetrahydrofurane, methanol, n-propanol, branched propanol, n-butanol, branched butanol and alcohol.

In one aspect, disclosed herein is a method for reducing the population of at least one bacteria species. The method comprises isolating and purifying at least one active ingredient from at least one part of a pepper plant, a musa plant or a Gongronema plant; forming a formulation by adding the at least one active ingredient to a carrier; and killing of the at least one pest when the at least one pest is at least in close proximity with the formulation. In some instances the method may not effectuate killing of the at least one pest, but rather reduces the proliferation of the at least one pest.

In some embodiments, the at least one bacteria species is at least one oral bacteria species. In some embodiments, the at least one bacteria species excludes proteus mirabilis, Esherichial coli, Staphylococcus aureus, or Candida albicons. In some instances, the pest excludes pests grown on yam (or another species of sweet potato). In some instances, the pest excludes pests affecting yarn (or another species of sweet potato).

In some cases, when the when the formulation comprises between zero and one parts per trillion (ppt) of the at least one active ingredient, the formulation is able to reduce the population of the at least one oral bacteria species by 90% within at most 60 seconds. In some cases, when the formulation comprises from greater than zero and up to one hundred parts per billion or more of the at least one active ingredient, the formulation is able to reduce the population of the at least one oral bacteria species by 90% within at most ten seconds.

In some embodiments, the reducing occurs when the at least one active ingredient concentration in the formulation is from greater than zero and up to 20 parts per million or higher. In some embodiments, the reducing occurs within at most 60 seconds.

The at least one oral bacteria species can be selected from the group consisting of Streptococcus mutans, Treponema denticola, Porphyromonas gingivalis Actinobacillus actinomycetemcomitans, Streptococcus sanguis, Streptococcus mutans, Lactobacilli, Actinomyces, Streptococcus mitis, Streptococcus oralis, Streptococcus gordonii, Staphylococcus aureus, Staphylococcus epidermidis, Veillonella, Neisseria sicca, Fusobacterium, Corynebacterium, Prevotella, Actinomyces israelii, Actinomyces naeslundii, Streptococci, spirochetes, Treponema denticola Bacteroides Porphyromaonas gingivalis, Actinomyces naeslundii, Spirochetes, Porphyromaonas gingivalis, Spirochetes, Fusiform bacilli, Actinobacillus actinomycetemcomitans, Porphyromaonas gingivalis Fusobacterium nucleatum, Herpes simplex virus, Streptococcus salivarius, Streptococcus gordonii, Streptococcus sobrinus, Candida albicans, Streptococcus mutans, Selenomonas, Actinobacillus actinomycetemeomitans, Porphyromonas gingivalis, Treponema denticola, Prevotella intemiedia, Capnocytophaga, Tannerella forsythensis, Porphyromonas endodontalis, Eubacteria, Streptococcus pyogenes, Streptococcus pneumoniae, Haemophilus influenza and Haemophilus parainfluenzae.

In some cases, the at least one bacteria species is related to human odor. In some cases, the human odor is foot odor, armpit odor, vaginal odor, rectal odor, or scalp odor.

In various embodiments, the at least one bacteria species is a bacteria from the genus Coryebacteria, Staphylococci, Providencia vermicola, Morganella morgana, Proteus mirabilis, Enterococcus faecalis, microbacterium lactium, or Bacterial indole.

In some cases, the at least one bacteria species is at least one acne related bacteria species. In some cases, the at least one bacteria species is a bacteria from the genus propionibacterium.

Formulation of the methods and composition for the disclosure can comprise from more than zero and up to 20 parts per million (ppm) of the at least one active ingredient, the formulation is able to reduce the population of the at least one acne related bacteria species by 90% within at most eight (8) hours.

In one aspect, there is described herein a method for reducing the population of at least one fungus. The method may comprise isolating and purifying at least one active ingredient from at least one part of a pepper plant, a musa plant or a Gongronema plant; forming a formulation by adding the at least one active ingredient to a carrier; and killing the at least one pest when the at least one pest is at least in close proximity with the formulation, wherein the fungus excludes an edible mushroom. In some instances the method may not effectuate killing of the at least one fungus, but rather reduces the proliferation of the at least one fungus.

In various embodiments, the fungus can comprise a fungus of the family plectosphaerellaceae. The fungus can comprise a fungus of the Aseomycota division. The fungus can comprise a fungus of the genus Verticillium. The fungus can be Verticillium fungicola. In some cases, the fungus can comprise a mold selected from the group consisting of green mold Trichoderma spp., Penicillium cyclopium and Aspergillus spp. In some cases, the fungus can be an animal fungus selected from the group consisting of Trichophyton rubrum Trichophyton interdigitale and Epidermophyton floccosum. The fungus can be a dermatophyte.

The formulation can further comprise an absorbent. The carrier can comprise clay, talc, or powdery starch.

As disclosed herein, a method for reducing animal itching can comprise isolating and purifying at least one active ingredient from at least one part of a pepper plant, a musa plant or a Gongronema plant; forming a formulation by adding the at least one active ingredient to a carrier; and relieving the animal itch when the at least itching area on said animal is at least in close proximity or contact with the formulation.

The carrier can comprise of a fluid. The carrier can comprise a colloidal material.

As described herein, a method for reducing noxious odor of an environment can comprise isolating and purifying at least one active ingredient from at least one part of a pepper plant, a musa plant, a piper plant or a Gongronema plant; forming a formulation by adding the at least one active ingredient to a carrier; and introducing the formulation to the environment; and reducing the noxious odor to a noxious odor level that is not detectable by an average human.

Disclosed herein is a method for reducing the population of at least one pest comprising forming a formulation by adding a compound selected from the group consisting of oxo-phenylethylamine, caryophyllene, alpha-pyrene, beta pyrene, cyclolanost and gammacerane; causing a contact or a close proximity between the pest and the formulation; causing a contact or a close proximity between the pest and the formulation; and killing the at least one pest when the at least one pest is at least in close proximity with the formulation. In some instances the method may not effectuate killing of the at least one pest, but rather reduces the proliferation of the at least one pest. In some instances causing a contact or a close proximity between the pest and the formulation comprises contacting the pest with the formulation.

The formulation for use of the present disclosure when is from above zero and up to one parts per billion (ppb) of the compound, it is able to reduce the population of the at least one pest by at least 90% in 120 seconds or less.

In some embodiments, the alpha-pyrene or beta-pyrene comprises an isolated and purified alpha-pywne or isolated and purified beta-pyrene found in an organic solvent extract of an aframornum melegueta (alligator pepper) plant part. In some embodiments, the alpha-pyrene or beta-pyrene comprises an isolated and purified alpha-pyrene or isolated and purified beta-pyrene found in an organic solvent extract of a xylopia aethiopica (uda) plant part. In some embodiments, the caryophyllene comprises an isolated and purified caryophyllene or caryophyllene derivative found in an organic solvent extract of a xylopia aethiopica (uda) plant part. In some embodiments, the oxo-phenylethylamine can comprise an isolated and purified oxo-phenylethylamine found in an organic solvent extract of a Gongronema latifolium (Utazi) plant part. In some embodiments, the the cyclolanost is comprises an isolated and purified cyclolanost found in an organic solvent extract of a musa plant part. In various embodiments, the gammacerane can comprises an isolated and purified gammacerane found in an organic solvent extract of a musa plant part. In various embodiments, the oxo-phenylethylamine can comprise an isolated and purified oxo-phenylethylamine found in an organic solvent extract of an Gongmnema latifolium (Utazi) plant part. The oxo-phenylethylamine can comprise an isolated and purified oxo-phenylethylamine found in an organic solvent extract of a purified Gongronema latifolium (Utazi) plant part. In various embodiments, the phenylethylamine comprises a 2′-(R₁)-oxy-N-(R₂)-2-oxo-2-phenylethylamine. The R₁ and R₂ can be alkyl chains. The R₁ and R₂ can be branched or linear. The R₁ and R₂ can be different. The R₁ and R₂ can be identical. In some cases, the phenylethylamine comprises a 2′-methoxy-N-methyl-2-oxo-2-phonylethylamine. In some cases, the cyclolanost comprises 9,19-eyclolanost-25-en-3-ol or a 9,19-cyclolanost-25-en-3-ol derivative. The 9,19-cyclolanost-25-en-3-ol can be a 24 methyl derivative. The 9,19-cyclolanost-25-en-3-ol can be a 3-beta, 24 ethyl derivative. The gammacerane comprises (C14a)-homo-27-nor-14-beta-gammacerane-3 alpha-ol.

The method can further comprise an amphiphilic. The method can further comprise an acid amphiphilic. In some cases, the acid amphiphilic can be a long chain aliphatic amphiphilic. The method can further comprise hexadecanoic acid or a derivative thereof.

Disclosed herein is also a method for reducing the population of at least one pest comprising forming a formulation by adding a compound selected from the group consisting of aliphatic acid, aliphatic ester, pyrimidil, Karane, Allopregnan, Copaene, Bicyclo[3.1.1] and Allopregnan; causing a contact or a close proximity between the pest and the formulation; and killing the at least one pest when the at least one pest is at least in close proximity with the formulation. In some instances the method may not effectuate killing of the at least one pest, but rather reduces the proliferation of the at least one pest.

The formulation can be from above zero and up to 20 parts per million (ppm) of the compound. The formulation can be able to reduce the population of the at least one pest by at least 90% in four hours or less.

The aliphatic (i.e. aliphatic moiety) can comprise hexanoic, heptanoic, octanoic, nonanoic, decanoic, undecanoic or dodecanoic. The ester can be methyl, ethy, propyl, butyl, pentyl, hexyl, heptyl, oetyl, nonyl or octyl ester. The Bicyclo[3.1.1] can be Bicyclo[3.1.1]hept-2-one-2-methanol, 6R₁,6R₂, or Bicyclo[3.1.1]hept-3-en-2-one, 4R₁,6R₂,6R₃. In some cases, R₁, R₂ or R₃ is selected from the group consisting of methyl, ethyl, propyl, butyl, pentyl, hexyl, heptyl, octyl, nonyl and octyl. The Allopregan can comprise Allopregnim-3.alpha.ol-20-one. The Kaurane can comprise Kaurane-16-ol, Kaurane-18-ol or Kaurane-16,18-diol. The pyrimidine can comprise Benzenesulfonamide, N-[2-(dimethylamino)-5-pyrimidinyl) or Benzenesulfonamide, N-[2-(diethylamino)-5-pyrimidinyl). The aliphatic ester can be a Methyl ester or ethyl ester of the compound selected from the group consisting of 9,12-Octadecadienoic acid, 10-Octadecanoic acid. Octadecanoic acid, hexadecanoic acid and linoleic acid.

In an aspect is described herein a method for reducing noxious odor of an environment. The method can comprise forming a formulation by adding a compound selected from the group consisting of aliphatic acid, aliphatic ester, pyrimidil, Kurane, Allopregnan, Copaene, Bicyclo[3.1.1] and Allopregnan; forming a formulation by adding the at least one active ingredient to a carrier; introducing the formulation to the environment; and reducing the noxious odor to a noxious odor level that is not detectable by an average human.

In an aspect is described herein a method for reducing noxious odor of an environment. The method can comprise forming a formulation by adding a compound selected from the group consisting of oxo-phenylethylamine, caryophyllene, alpha-pyrene, beta-pyrene, cyclolanost and gammacerane, forming a formulation by adding the at least one active ingredient to a carrier; introducing the formulation to the environment; and reducing the noxious odor to a noxious odor level that is not detectable by an average human.

Additional embodiments relating to the further invention will be apparent from the following detailed description.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features arc arbitrarily expanded or reduced for clarity. Included in the drawings are the following figures.

FIG. 1 depicts fungus growing on non-treated uda.

FIG. 2 depicts fungus eliminated from uda after treatment with the at least one active ingredient applied in the form of water vapor comprising the active ingredient.

FIG. 3 depicts Verticillium infection causes dries mushroom and fungal infection results in formation of mycelium on the growing mushroom (FIG. 3A). Pest such as flies are attracted to the Verticillium infected mushroom (FIG. 3B).

FIG. 4 depicts mushrooms free of insects and fungi after application of water vapor comprising the at least one active ingredient.

FIG. 5 illustrates a worker applying the formulation comprising the at least ono active ingredient in the form of an aqueous spray on the walls of a mushroom grow house.

FIG. 6 depicts insects such as flies that are trapped and killed on the wall of a mushroom grow house after the formulation (comprising the at least one active ingredient) has been spread on the wall.

FIG. 7 a mushroom grow house wall after application of the formulation comprising the at least one active ingredient, and subsequent cleaning with an aqueous suspension (e.g. water).

FIG. 8 illustrates a comparison (right half of figure compared to left half of figure) between, mushrooms grown without application of the at least one active ingredient in any form (left half of FIG. 8) and mushrooms grown with the application of the formulation in the form a water vapor comprising the at least one active ingredient (right half of FIG. 8).

### DETAILED DESCRIPTION

Disclosed herein are compositions, formulations, methods and systems for suppression of varies species of pests, e.g. mushroom pests. The compositions, formulations, systems and methods disclosed herein are achieved by utilizing a composition comprising isolated and purified natural plant-based materials, or other natural plant-based organic matter, formulated by adding at least one active ingredient to a carrier, for use as a pesticide (e.g. insecticide or fungicide). In some instances, the compositions, formulations, systems and methods may be used as a bactericide. The compositions, formulations, systems and methods may be used as an odor suppressant for use in an environment. The compositions, formulations, systems and methods may be utilized in suppressing odor of animals or animal excretions. In some embodiments the animal is a pet, laboratory animal, domestic animal, farm animal or wild animal. The animal may be vertebrates, mollusks, arthropods, annelids or sponges. Sometimes, the animal is a bird, mammal, amphibian, reptile or fish. Sometimes, the vertebrate is a bird, mammal, amphibian, reptile or fish. In some instances, the mammal is a primate, ape, dog, cat, rodent, rabbit or ferret. In some instances, the rodent is a gerbil, hamster, chinchilla, fancy rat, or guinea pig. In some instances, the bird is a canary, parakeet or parrots. In some examples, the reptile is a turtles, lizard or snake. In some instances, the fish is a tropical fish. In some instances, the amphibian is a frog. In some instances the arthropod is a tarantula or hermit crab. The compositions, formulations, systems and methods may be utilized in suppressing odor of humans. In some instances, the human is a healthy human. In some examples, the human is a human that is not healthy. In various aspects, utilization of the systems, methods and compositions can reduce the amount of pests. The pest may be, at least one insect, at least one bacterium, and at least one fungus. The formulation or composition may reduce the activity of the pest when the pest is in close proximity with the formulation or composition, or when the pest is in contact with the formulation or composition. The formulation or composition may kill the pest when the pest is in close proximity with the thrmulation or composition, or when the pest is in contact with the formulation. The systems, methods, formulation and compositions can reduce odor of an environment or an animal including, human, pet, and livestock.

The active ingredient, composition or formulation may be effective against edible (e.g, edible to humans) mushroom pests and their larvae including, phorids, cecids, sciarids, myeetophils, scaptosids, house flies, horse flies, mites, spiders, and Verticillium. As an example, the Cecid fly can be Mycophila speyeri or Heferopeza pyginaea. The composition has high efficiency in killing or suppressing the activity or the vitality of one or more edible mushroom pest, a grape pest, greenhouse pest or a landfill pest. The attractant can be modified to control, kill or suppress the growth or the vitality of pests such as flies, bees, mosquitoes, ants, cockroaches, grasshoppers, wasps, stick-bugs, ticks, beetles, termites, crickets, caterpillars, butterflies, moths, or dragonflies. Flies may include arachnids, tsetse fly, gnats or sand flies. The attractant can be modified to control, kill or suppress the growth or the vitality of animals having an exoskeleton. The attractant can be modified to control, kill or suppress the growth or the vitality of a virus, a bacteria, a mono cellular organism, a worm or a maggot. The attractant can be modified to control, kill or suppress the growth or the vitality of an insect species comprising Coleoptera, Diptera, Hymenoptera or Lepidoptera.

The active ingredient, composition or formulation of this disclosure is produced from organic edible materials. The active ingredient, composition or formulation exhibits low toxicity to animals and humans. In some instances, the waste by-products of the compositions, formulations, systems or methods are environmentally nontoxic and biodegradable. Sometimes, the organically formulated compositions, formulations, systems or methods do not contain toxic pesticides.

The compositions, formulations, systems or methods can comprise biomass materials from animal or plant sources. In some cases, the active ingredients, compositions or formulations can be synthesized from industrial organic biomass, non-industrial organic biomass, or a combination thereof. In one example the biomass material comprises of organic biomass waste from plants. The biomass waste may comprise of extracts from parts of a plant and their related various hybrids, for example, ripe or unripe fruits and skins of the fruit, leaves, stems, barks, roots, seeds, pods, and flowers of the plant. The biomass materials can be discarded parts of a plant, old parts of plants, fermented parts of plants, dry plants of plants, fresh parts of plants, or a combination thereof. In various embodiments, the biomass material may comprise one or more plants in the genus Musa, Xylopia, Aframomum, Gongronema or Piper.

In some cases, the plant (e.g. biomass) may comprise of extracts from parts of the plants from the genus Musa and related species. As a non-limiting example, plants from the genus Musa comprise the species M. paradisiaca, M. sapientum, M. acuminata, M. basjoo, M. cheesmanit, M. chunii, M. griersonii, M. itinerans, M. laterita, M. mannii, M. nagensium, M. ochracea, M. ornata, M. rosea, M. rubinea, M. rubra, M. sanguinea, M. schizocarpa, M. siamensis, M. sikkimensis, M. thomsonii, M. velutina, M. yunnanensis, M. balbisiana, M. corniculata or M. zaifui. In some embodiments, the plant can be Musa paradisiaca, Musa sapientum, or a hybrid of the plants. In some embodiments, the plant is commonly known as banana or plantains.

The plant may comprise a plant from the genus Xylopia or a related species. Exemplary plants from the genus Xylopia include, but are not limited to X. aethiopica, X. africana, X. amplexicaulis, X. aethiopica, X. aromatica, X. championii, X. ekmanii, X. elliotii, X. elliptica, X. frutescens, X. ferruginea, X. hastarum, X. lamarckii, X. latipetala, X. longifolia, X. magna, X. pierrei, X. richardii, X. sericea, or X. talbotii. In some embodiments, the plant can be Xylopia aethipica, commonly known as Uda.

The plant may comprise of plants from the genus Aframomum and related species. As an non-limiting example, the plant can be A. danielli, A. citratum, A. exscapum, and A. melegueta. In some embodiments, the plant for use of the present composition can be Aframomum melegueta, commonly known as alligator pepper.

The plant may comprise plant from the genus Gongronema and related species. Exemplary plants from the genus Xylopia include, but are not limited to, G. angolense, G. bracteolatum, G. curtisii, G. filipes, G. finlaysonii, G. gaudichaudit, G. gazense, G. latifolium, G. multiibracteolatum, G. nepalense, G. obscurum, G. taylorii, G. thomsonii, G. veniricosum, G. wallichii, and G. wrayi. In some cases, the plant can be Gongronema latifolium, commonly known as Utazi.

The plant may comprise a plant of the genus Piper and related species. Exemplary plants from the genus Piper include, but are not limited to, P. capensis, P. achupallasence, P. aduncum, P. aequilaterum, P. amalgo, P. angamarcanum, P. auritum, P. azuaiense, P. baezanum, P. baezense, and P. begoniiforme. In some embodiments, the plant can be Piper capensis, commonly known as Uzazi.

In various embodiments, isolation and/or purification of the active ingredient can be achieved by using an organic solvent selected from the group consisting of an aliphatic compound, and ester and an alcohol. Non-limiting examples include ethyl acetate, hexane, heptane, dimethylsulfoxide, diethylether, tetrahydrofurane, methanol, n-propanol, branched propanol, n-butanol, branched butanol and alcohol. The organic solvent may be any aliphatic solvent such as for example an aliphatic solvent having 1 carbons, 2 carbons, 3 carbons, 4 carbons, 5 carbons, 6 carbons, 7 carbons, 8 carbons, 9 carbons, 10 carbons, 12 carbons, 13 carbons, 14 carbons, 15 carbons, 16 carbons, 17 carbons, 18 carbons, 19 carbons, 20 carbons or more. The organic solvent may a ketone having 1 carbons, 2 carbons, 3 carbons, 4 carbons, 5 carbons, 6 carbons, 7 carbons, 8 carbons, 9 carbons, 10 carbons, 11 carbons, 12 carbons, 13 carbons, 14 carbons, 15 carbons, 16 carbons, 17 carbons, 18 carbons, 19 carbons, 20 carbons or more. The long chain may be linear or branched. The organic solvent may an ester having 1 carbons, 2 carbons, 3 carbons, 4 carbons, 5 carbons, 6 carbons, 7 carbons, 8 carbons, 9 carbons, 10 carbons, 11 carbons, 12 carbons, 13 carbons, 14 carbons, 15 carbons, 16 carbons, 17 carbons, 18 carbons, 19 carbons, 20 carbons or more. The organic solvent may an alcohol having 1 carbons, 2 carbons, 3 carbons, 4 carbons, 5 carbons, 6 carbons, 7 carbons, 8 carbons, 9 carbons, 10 carbons, 12 carbons, 13 carbons, 14 carbons, 15 carbons, 16 carbons, 17 carbons, 18 carbons, 19 carbons, 20 carbons or more. The long chain may be linear or branched. The organic solvent may a ketone having 1 carbons, 2 carbons, 3 carbons, 4 carbons, 5 carbons, 6 carbons, 7 carbons, 8 carbons, 9 carbons, 10 carbons, 11 carbons, 12 carbons, 13 carbons, 14 carbons, 15 carbons, 16 carbons, 17 carbons, 18 carbons, 19 carbons, 20 carbons or more. The long chain may be linear or branched. Isolation and/or purification of the active ingredient may comprise the use of carbon dioxide, such as liquid carbon dioxide in supercritical carbon dioxide liquid extraction. Isolation and/or purification of the active ingredient may comprise water or steam at high temperature, or at a temperature above ambient temperature (e.g, 25 degrees Celsius).

The active ingredient of this disclosure can be isolated and/or purified from plants from the genus Dioscorea, for example extracts from the leaves and the skin of yam. In one embodiment, the attractant-pesticide of this invention can be isolated and purified from the extracts of the skin of plants from the genus Colocasia, for example extracts of the skin of cocoyam.

The active ingredient of this disclosure can be isolated and/or purified from the plants from the family Bromeliaceae, for example extracts of the skin and leave of the pineapple.

In one embodiment, composition or formulation may include plantain, Utazi, Uzazi, alligator pepper (Aframomum melegueta), Uda (Xylopia aethipica), Ehuru (Monodora myristica), both alligator pepper and Uda, or any combination thereof. The active ingredients may be further combined with a surfactant. The surfactant may be a soap (e.g. a biodegradable soap). The active ingredient may be combined with polyethylene glycols. The active ingredient may be further combined with a catalyst (e.g. titanium oxide). The active ingredient may be further combined with a dye (e.g. a fluorescent dye).

The active ingredient of this disclosure can be extracted and/or purified from the plants from the genus Carica (e.g. form the skin of Carica). For example, from the papaya plant Carica papaya. In one embodiment, the extracts of Carica papaya can be combined with the extracts from alligator pepper to formulate a novel organic pesticide. In one embodiment, the various extracts from alligator pepper and Carica papaya of this disclosure can be combined with a biodegradable soap or polyethylene glycols.

The active ingredient of this disclosure can be extracted and/or purified from the extracts of the skin of plants from the family Euphorbiaceous, for example alcoholic extracts of the leaves or and the pericarp or and the bark of the root and stem of castor oil (Ricinus communis), or extracts of the skin the cassava root (Manihol esculenta). The extracts of castor oil or from the Euphorbiaceous family may be combined with the extracts from alligator pepper to formulate a novel organic pesticide. In one embodiment, the various extracts from alligator pepper and castor oil of this disclosure can be combined with a second agent, e.g. a biodegradable soap. The composition or formulation may further comprise an aroma. In some exemplary embodiments, the aroma is an agent imparting an odor, fragrance or smell with the basic known fragrance characteristics or any combination thereof. For example, basic fragrance characteristics comprise sweet, pungent, acrid, fragrant, warm, dry, sour, or any combination thereof. Examples for aroma agents comprise carbonyl compounds, pyranones, furanones, thiols, thioethers, di- and trisulfides, thiophenes, thiazoles, pyrroles, pyridines, pyrazines phenols, alcohols, hydrocarbons, esters, lactones, terpenes, volatile sulfur compounds, or any combination thereof.

As described herein, the active ingredient of this disclosure can be extracted and/or purified from plants from the Allium genus or onion genus, for example extracts of onion, garlic, chives, scallion, shallot, or the leek can be used to formulate organic attractant and pesticide of this disclosure. Other edible plants extracts that may be used but not limited include an extract from Celery, African basil Ocimum gratissimum, (Family Labiatae), Okazi (Igbo) (Gnetum africanum, Family Gnetaceae), Utazi Pergularia daemia of the plant family Aselepiadaceae, Uziza or Benin pepper (Piper guineense) of plant family Piperaceae, Bitter leaf (Vernonia amygdalina), cocoa pod skin, pericarp (Theobroma cacao) or including cocoa waste and the various combinations thereof.

The animal biomass may include both marine and freshwater animals, including vertebrates and invertebrates. In another embodiment, for example, mollusks such as cephalopods, gastropoda, and bivalvia species may be used as the precursor material. For example, alcoholic extracts of cuttlefish, mussels, octopus, and squids may be used alone or combined with clams, oysters, scallops, mussel, snails, slug and their likes for precursor material. In other embodiment, marine water biomass or fresh water biomass may be used alone or in combination. In one embodiment, terrestrial biomass waste may be combined with fresh water or marine biomass for precursor material.

In one example hexane, dimethylsulfoxide, dimethylformamide, ether, ethyl acetate or alcoholic extracts of edible plant part. Any plant part may be used. For example the skin of the plant, the skin of the plant, or both. For example, plantain skin or castor oil seed, may be combined with alcoholic extracts of cephalopods to formulate the organic pesticide of this invention.

In various embodiments, the composition of the disclosure comprising the active ingredient can be combined and mixed with one or more agents such as gel, wax, mineral oil, vegetable oil, animal oil, polyethylene glycols, surfactants (e.g., soap), a hydrophilic carrier, an aqueous carrier, dyes, and/or clays. In certain occurrences, the oil may be any vegetable oil or any animal oil. For example, vegetable oil comprises olive oil, palm oil, soybean oil, canola oil (rapeseed oil), avocado oil, coconut oil, pumpkin seed oil, corn oil, sunflower oil, safflower oil, peanut oil, grape seed oil, sesame oil, agan oil or rice bran oil. Animal oil comprises butter, ghee or lard. In some cases, the carrier can comprise an emulsion, a suspension, a paste, a gel, a solid, or a solution.

In some cases, the composition can further comprise one or more catalyst, wherein the catalyst comprises an inorganic compound such as metal oxides. The metal oxides may include magnesium oxide, aluminum oxide, titanium oxide, iron oxides, nickel, nickel oxides, calcium oxides, platinum or platinum complexes. The inorganic compound may catalyze a reaction between the various extracted active ingredients. The inorganic compound may serve as an absorbent of the active ingredient. The inorganic compound may react with the at least one active ingredient to produce at least one product. The at least one product may be effective in killing or suppressing the activity of a pest (including a bacteria).

As described herein, the composition or formulation can comprise one or more dye. The dye can be a fluorescence dye. The dye may be water soluble. For example, the dye may be fluorescein. In some embodiments, the dye is selected from the group consisting of Fluorescein, Eosin, Carboxyfluorescein, Fluorescein isothiocyanate, Merbromin, Rose bengal and a member of the DyLight Fluor family. The dye may be Erythrosine (FD&C Red #3; E127). In some embodiments, the dye is FD&C Red #40 (E129, Allura Red AC) or FD&C Orange #2.

In some exemplary embodiments, the dye is any natural or artificial food coloring. Natural food coloring is Annatto (E160b), Betanin (E162), Butterfly pea (Clitoria ternatea), Caramel coloring (E150), Chlorophyllin (E140), Elderberry juice, Lycopene (E160d), Cochineal (E120), Pandan (Pandanus amaryllifolius), Paprika (E160c), Tumieric (curcaminoids, E100), Saffron (carotenoids, E160a), beet color, berry color, red cabbage color. Berry color derives from strawberry, blueberry, currant, raspberry, mulberry, grape, gooseberry, wolfberry (goji-berry) and any combination thereof. Artificial food coloring is FD&C Blue No. 1—Brilliant Blue FCF, E133 (blue shade), FD&C Blue No. 2—Indigotine, E132 (indigo shade), FD&C Green No. 3—Fast Green FCF, E143 (turquoise shade), FD&C Red No. 3—Erythrosine, E127 (pink shade, commonly used in glacé cherries), FD&C Red No. 40—Allura Red AC, E129 (red shade), FD&C Yellow No. 5—Tartrazine, E102 (yellow shade), FD&C Yellow No. 6—Sunset Yellow FCF, E110 (orange shade), any other governmentally authorized food coloring, or any combination thereof.

In some embodiments, the formulation or composition comprises an anti-caking. The anti-caking agent can be E341 tricalcium phosphate, E460(ii) powdered cellulose, E470b magnesium stearate, E500 sodium bicarbonate, E535 sodium ferrocyanide, E536 potassium ferrocyanide, E538 calcium ferrocyanide, E542 bone phosphate, E550 sodium silicate, E551 silicon dioxide, E552 calcium silicate, E553a magnesium trisilicate, E553b talcum powder, E554 sodium aluminosilicate, E555 potassium aluminium silicate, E556 calcium aluminosilicate, E558 bentonite, E559 aluminium silicate, 570 stearie acid or E900 polydirnethylsiloxane.

In some exemplary embodiments, the formulation or coposition comprises an anti-microbial agent. The anti-microbial agent may comprise an anti-microbial essential oil, benzoic acid, PHB esters, sorbic acid, propionic acid, acetic acid, sodium sulfite and sodium metabisulfite, diethyl pyrocarbonate, ethylene oxide, propylene oxide, nitrite, nitrate, antibiotics, diphenyl, o-phenylphenol, thiabendazole or any combination thereof. Sometimes, the anti-microbial (antimicrobial) essential oil is Cinnamon oil, Clove oil, Eucalyptus oil, Garlic, Oregano oil, Lavender oil, Leleshwa oil, Lemon oil, Lemon myrtle oil, Mint oil, Neem oil, Nigella sativa (black cumin) oil, Onion oil, Peppermint oil, Sandalwood oil, Ironwort, Tea tree oil, Thyme oil, or any combination thereof.

In some exemplary embodiments, the composition or formulation comprises an antioxidant. The antioxidant (anti-oxidant) agent may comprise vitamin E, vitamin E complex, tocopherols, 2,6-di-tert-batyl-p-cresol (BHT), tert-butyl-4-hydroxyanisole (BHA), propylgallate, octylgallate, dodecylgallate, ethoxyquin, ascorbyl palmitate, ascorbic acid (Vitamin C), alpha caroten, astaxantin, beta carotene, (vitamin A), canthaxantin, luthein, lycophene, zeaxanthin, curcumin, Flavonolignans, xanthones, Eugenol, chicoric acid, chlorogenic acid, cinnamic acid, ellagic acid, elagitannins, gallic acid, gallotannins, rosmarinic acid, salicylic acid, Flavonoid and any combination thereof. In some aspects, a flavonoid is a Favone, Flavonol, Flavanols, Flavanones, Isoflavone phytoestrogens, Stilbenoids, Anthocyanins, Pterostilbene or any combination thereof. Flavones is Apigenin, Luteolin, Tangeritin or any combination thereof. Flavonolsis Isorhamnetin, Kaempferol, Myricetin, Proanthocyanidins (or condensed tannins), Quercetin, rutin, or any combination thereof. In some examples, Flavanon is Eriodictyol, Hesperetin (metabolizes to hesperidin), Naringenin (metabolized from naringin) or any combination thereof. Sometimes, Flavanol comprises Flavanol polymers, Flanvanol is Catechin, gallocatechin and their corresponding gallate esters, Epicatechin, epigallocatechin and their corresponding gallate esters, Theallavin its gallate esters, Theambigin, or any combination thereof. In some examples, Isoflavone phytoestrogens comprise any members of the Fabaceae family Daidzein, Genistein, Glycitein, or any combination thereof. In some instances, Stilbenoids is Resveratroim, Pterostilbene (methoxylated analogue of resveratrol), or any combination thereof. In some instances, Anthocyanins is Cyanidin, Delphinidin, Malvidin, Pelargonidin, Peonidin, Petunidin, or any combination thereof.

The composition or furmulation may further comprise an absorbent, a colloidal material, and/or a clay. The clay can be bentonite clay or a ball clay. The clay may be selected from the group consisting of ball clay, bentonite clay, polymer clay, Edgar plastic kaolin, silicon powders, carbon particulates, activated carbon, volcanic ash, kaolinitic clays, montmorillonite, and treated saw dust. For example, the clay may be bentonite clay. The clay can be an aluminum phyllosilicate clay. The clay may comprise Montmorillonite. The clay can comprise an aluminum silicate. The clay may comprise Al₂O₃4SiO₂H₂O. The clay may comprise potassium (K), sodium (Na), calcium (Ca), titanium (Ti) and aluminum (Al). Occasionally, the clay can be produced by volcanic ash. The clay may be selected from the group consisting of illite clay, medicinal clay and zeolite. The clay may be ball clay. The clay may comprise kaolinite, mica and quartz. The clay comprises at least 15% kaolinite, at least 8% mica and at least 4% quartz.

In some examples, the active compound, formulation or compositions disclosed herein can be applied to the treated subject (e.g. mushroom, human, plant, landfill or animals) by means of a suitable device. The device can be a device that exerts spray or droplets containing the formulation. For example, the device may be a spraying device or dusting device. The device may be a humidifier or a hose. The composition or formulation may be diluted in water and sprayed directly or indirectly on the treated subject or on the pest. The composition can be formulated as a solution (e.g. solution to be sprayed), a gel, a paste, a foam, a lotion, a cream, an ornament, a chewing gum, or a semi-solid form. The composition can also be formulated in a concentrated aqueous solution which can subsequently be diluted before application to the subject or pest. In some cases, the compounds from the fermentation reaction may be further processed, filtered and diluted with water (or another hydrophilic or hydrophobic solvent) and sprayed or fogged to suppress the pests (including bacteria). In one example, solvent extraction of the fermented materials may be used for spraying and fogging applications.

In one embodiment of this invention, the solvent extract or the extract concentrate may be processes electrochemically using polar solvents or polar protic solvents to generate novel compounds with desirable properties.

Formulation of the composition can comprise fermentation. In one embodiment, the various precursor of this disclosure may be fermented to form a novel attractant-pesticide or treatments for diseases. The precursor material or materials can be fermented in a container. The container can be open, but preferably closed, during the fermentation process. The fermentation can be partially aerobic, but preferably anaerobic. In one embodiment, the container can be exposed to light or light of known wavelength, continuously or at desirable intervals. In another embodiment, photons are excluded form interacting with the contents of the vessel during the fermentation step. The fermentation reaction or attractant synthesis may occur between the temperatures of −10 to 90 degrees centigrade but preferably between 0 to 60 degrees centigrade. In some embodiment, the precursor material may be momentarily exposed in hot water for a period varying between 5 second to 60 second, prior to the fermentation step.

In some embodiments, the part of plant (such as Uda (Xylopia aethiopica), alligator pepper (Aframomum melegueta) or plantain) can be fermented alone or any combination thereof. Any part of the plant can be used, or a combination of various plant parts. For example, both the seed and the pod of the plant may be used. In one example dry ice and or yeast amongst other ingredients were used to assist the fermentation step. The fermentation step may be performed in a pressurized or semi-pressurized or variable pressure ambient. Alcoholic extract of the fermented materials can be formulated for mushroom pest control.

The parts of plants can be used for extraction of the active ingredient using an organic solvent. Suitable solvents can include aliphatic compound such as hexane, or hexene, ester such as ethyl acetate, and alcohol. For example, the precursor material or materials may be fermented as is, may be chopped in to smaller sizes or may be ground or milled to finer particulates or semi-solid before transferring to the fermentation vessel for the fermentation step. It is desirable that the chopping or milling process be performed at a temperature that does not degrade or destroy the precursor material of interest. The deployed synthesized attractant may contain partially fermented or fully fermented precursor materials solids, liquid, semi-solid. In one embodiment, hydrophilic solvents may be used to extract the most, elective components of the fermentation reaction. As an example, parts of the plants of Uda (Xylopia aethiopica), and alligator pepper (Aframomum melegueta), e.g. seed, pod, seed with pod, can be used for extraction. The purified and/or extracted active ingredients can then be mixed to form a formulation for killing pests (insects, fungi and bacteria), and/or for reducing odor in an environment. In one embodiment known amounts of the milled precursors are blended and solvent extract or super critical fluid carbon dioxide extract from the blend or blends may be dispersed in a suitable carrier or in a suitable extractant for subsequent application. The extractant can comprise an organic solvent, a hydrophilic solvent, a hydrophobic solvent, an amphiphile or a bola-amphiphile. In one example, about 50 grams of the plant parts. (e.g. uda and allegator pepper) can be soaked separately into about 200 mL of ethanol in a flask (e.g. conical flask with or without a rubber cork) and left for a predetermined period of time (e.g. 24 hours) undisturbed or with stirring. The plant part can be milled prior to or subsequent to soaking. The plant parts can be extracted via soxlet extraction. The plant parts can be extracted via by placing the plant parts in the extracting solvent (i.e. organic solvent) and elevating its temperature. The plant parts can be extracted via refluxing the organic solvent in which it is placed over a predetermined period of time. The solvent, extract and plant parts can be subsequently purified. Prification may he by chromatography or filtering. Chromatography may include HPLC, silica or alumina column chromatography, size exclusion chromatography, ion exchange chromatography and the line. Filtration may include filtration using filter paper (e.g. Whattman No. 1 filter paper), or filtering through a membrane. The organic solvent may be evaporated via evaporation means. Evaporation means may include rotary evaporator, de-humidifier, oven, lyophilizer, flowing or flowing a stream of gas (e.g. air) on the surface of the solution. The isolated and purified active ingredient obtained can be stored (e.g. at room temperature or in refrigerator at 4° C.) until used. At times, the extract in ethanol can be used without evaporation, or with partial evaporation.

Fermentation of the biomass can be enhanced by the addition of one or more species of bacteria to the composition. Typically, the bacteria are anaerobic bacteria and may be obligatory anaerobic, may facultatively anaerobic, or anaerobic bacteria that may tolerate oxygen. An addition of anaerobic bacteria to the biomass can be selected from bacteria that naturally resides within the natural flora of an animal gastrointestinal tract. Examples of bacteria may be added to the present composition for enhancing fermentation include, but are not limited to, Fusobacterium, Serratia, Enterobacteriacae, Bacteroides, Photorhabdus, Citrobacter, Pepiostreptococcus, Proteus, Peptoniphilus and Vagococcus. The bacteria added to the present composition are gram negative or gram positive bacteria. The bacteria may be from the tribe Proteae within the bacterial family Enterobacteriaceae including Proteus, Morganella and Providencia. The bacteria may be from the genus Morganella including Morganella morganii and Morgonella sibonii. In some embodiment yeast and/or dry ice may be added to the selected biomass for the fermentation step. Extract (e.g. solvent extract) of the fermented biomass or partially fermented biomass may be used with a carrier. In one embodiment extracts from fermented biomass may be combined with extracts from non fermented biomass at appropriate proportions. For example, 50% blend of extracts front the fermented biomass and 50% extract from the unfermented biomass extract. Other blending ratios may be used when appropriate; for example 10% from fermented biomass and 90% from unfermented biomass; 20% from fermented biomass and 80% from unfermented biomass; 30% from fermented biomass and 70% from unfermented biomass; 40% from fermented biomass and 60% from unfermented biomass; 50% from fermented biomass and 50% from unfermented biomass; 60% from fermented biomass and 40% from unfermented biomass; 70% from fermented biomass and 30% from unfermented biomass; 80% from fermented biomass and 20% from unfermented biomass; 90% from fermented biomass and 10% from unfermented biomass. Wherever a ratio is mentioned throughout this disclosure, it is a weight per weight (w/w) ratio, unless otherwise specified.

Fermentation of the biomass for use as insect attractant in this invention comprises adding one or more species of bacteria to the biomass including terrestrial or aquatic animal flesh, plant or marine organisms such as corals, sponges and algae. Examples of bacteria may be added to the present: composition for enhancing fermentation include, but are not limited to, Fusobacterium, Serratia, Enterobacterioceae, Bacteroides, Photorhabdus, Citrobacter, Peptostreptococcus, Proteus, Peptoniphilus and Vagococcus. The proportion of bacteria may vary and determine the effectiveness of the insect attractant. The percentage of a bacterium to the total population of bacteria can be from about 0.001% to 50%, about 0.05% to 1%, about 0.1% to 5%, about 2% to 10% about 3% to 15%, about 4% to 20%, about 6% to 25%, about 8% to 30%, about 12% to 35%, about 16% to 40%, about 18% to 45%. The percentage of a bacterium to the total population of bacteria can be from about 0.001%, about 0.01%, about 0.05%, about 1%, about 2%, about 3%, about 4%, about 5%, about 6%, about 8%, about 10%, about 12%, about 15%, about 20%, about 25%, about 30%, about 35%, about 40%, about 45%, about 50%, or more. The percentage of a bacterium to the total population of bacteria is less than about 0.001%, less than about 0.01%, less than about 0.05%, less than about 1%, less than about 2%, less than about 3%, less than about 4%, less than about 5%, less than about 6%, less than about 8%, less than about 10%, less than about 12%, less than about 15%, less than about 20%, less than about 25%, less than about 30%, less than about 35%, less than about 40%, less than about 45%, less than about 50%, or less. The percentage of a bacterium to the total population of bacteria can be greater than about 0.001%, greater than about 0.01%, less than about 0.05%, greater than about 1%, greater than about 2%, greater than about 3%, greater than about 4%, greater than about 5%, greater than about 6%, greater than about 8%, greater than about 10%, greater than about 12%, greater than about 15%, greater than about 20%, greater than about 25%, greater than about 30%, greater than about 35%, greater than about 40%, greater than about 45%, greater than about 50% or more.

It is to be understood herein that wherever a number is identified, it is accurate within 10 percent of the identified number.

In some embodiments, fluorescent agents, for example non-toxic fluorescent fluorescing dyes, may be mixed with the precursor material before the fermentation process. In other embodiments, the fluorescing dyes may be incorporated into the attractant before deployment. The fluorescent dye may be hydrophilic or hydrophobic in nature. For example, the attractant of this invention may comprise of a fluorescing ultra-violet dye or dyes that fluoresce within visible and non-visible spectrum of light. For example, a very small amount of AutoPro 375 Antifreeze/Coolant UV Dye 1, (supplied by IDQ Corporation—2901 West Kingsley Road, Gartland Tex. 75041) may be added to the precursor material prior to the fermentation step. The concentration of the dye may vary between 0.01 ppm to 10 ppm. In some applications, the dye may be incorporated into the unfermented attractant-pesticide. Also, in some applications the attractant may comprise of a single or multiple dyes.

The dye can be selected from the group consisting of acridine dyes, cyanine dyes, fluorone dyes, oxazin dyes, phenanthridine dyes, and rhodamine dyes. The dye can be selected from the group consisting of erythrosine (FD&C Red #3; E127), FD&C Red #40 (E129, Allura Red AC), FD&C Orange #2, eosin, carboxyfluorescein, fluorescein isothiocyanate, merbromin, rose bengal, members of the DyLight Fluor family, acridine orange, acridine yellow, AlexaFluor, AutoPro 375 Antifreeze/Coolant UV Dye 1, benzanthrone, bimane, bisbenzimidine, blacklight paint, brainbow, calcein, carboxyfluorescein, coumarin, DAPI, DyLight Fluor, Dark quencher, Epicocconone, ethidium bromide, Fluro, Fluorescein, Fura, GelGreen, GelRed, Green fluorescent protein, heptamethine dyes, Hoechst stain, Iminoconmarin, Indian yellow, Indo-1, Laurdan, Lucifer yellow, Luciferin, MCherry, Merocyanine, Nile blue, Nile red, Perylene, Phioxine, Phycobilin, Phycoerythrin, Pyranine, Propidium iodide, Rhodamine, RiboGreen, RoGFP, Rubrene, Stilbene, Sulforhodamine, SYBR dyes, tetraphenyl butadiene, Texas red, Titan yellow, TSQ, Umbelliferone, Violanthrone, Yellow fluorescent protein, and YOYO. The dye can be erythrosine (FD& C Red #3; E127). The dye can be FD&C Red #40 (E129, Altura Red AC). or FD&C Orange #2. The dye can be fluorescein.

In another embodiment of this invention, the formulated attractant-pesticide may be admixed or combined with semi-solid tacky adhesive and spayed on a surface for mechanical kill by immobilization of the pest. In another embodiment of this invention, the composition or formulation may comprise alligator pepper extract and uda extract. In some instances, the composition or formulation further comprises a surfactant (e.g. biodegradable soap) or a dye. The surfactant or the dye may attract the pests. The insect pests may be immobilized or killed by the wetting aetion of the soap against wings or the feet of the insect pest.

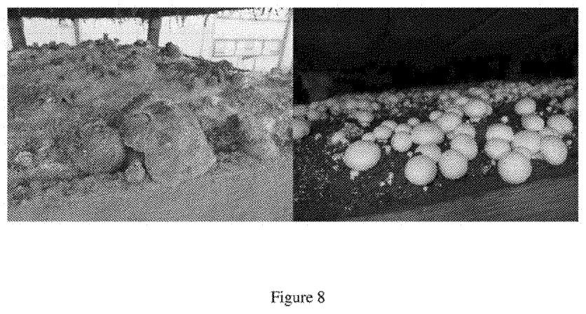

For example one 1 liter of the extract comprising of 300 g/L of Uda and 100 g/L of Alligator pepper alcohol extract was incorporated in 4 liter of water to to a mushroom house in the presence of live mushroom. In another application, the formularies from this invention were used to fog rooms heavily infested with mushroom pests. Results of the fogging operation confirm the organic pesticide attracts the various mushroom pests in inordinate number and before killing them off, without adversely affecting the growing mushroom as can be seen in FIG. 8. For heavily infested rooms with complete crop failure, the fogging operation lead to massive extermination of the mushroom pests in the room. In one embodiment, the formulation comprising of biodegradable soap is preferably used on structures and surrounding infra-structure away from growing areas, for an even more aggressive kill off of the pests. In one application, the formulary with soap may be sprayed to clean or decontaminate empty growing rooms and equipment.

In some examples both alligator seed and pod and Uda can be used. The ratio of alligator popper (e.g. seed and/or pod) to Uda can be 1 to 0.01, about 1 to 0.05, about 1 to 0.1, about 1 to 0.2, about 1 to 0.5, about 1 to 1, about 1 to 1.5, about 1 to 2, about 1 to 2.5, about 1 to 3, about 1 to 4, about 1 to 5, about 1 to 6, about 1 to 7, about 1 to 8, about 1 to 9, about 1 to 10, about 1 to 15, about 1 to 20, about 1 to 25, about 1 to 30, about 1 to 40, about 1 to 50, about 1 to 60, about 1 to 70, about 1 to 80, about 1 to 90, about 1 to 100, about 1 to 120, about 1 to 150, about 1 to 180, about 1 to 200, or about 1 to a greater ration than 200. In some examples both alligator seed and pod and Uda can be used. The ratio of Uda to alligator pepper (e.g. seed and/or pod) can be 1 to 0.01, about 1 to 0.05, about 1 to 0.1, about 1 to 0.2, about 1 to 0.5, about 1 to 1, about 1 to 1.5, about 1 to 2, about 1 to 2.5, about 1 to 3, about 1 to 4, about 1 to 5, about 1 to 6, about 1 to 7, about 1 to 8, about I to 9, about 1 to 10, about 1 to 15, about 1 to 20, about 1 to 25, about 1 to 30, about 1 to 40, about 1 to 50, about 1 to 60, about 1 to 70, about 1 to 80, about 1 to 90, about 1 to 100, about 1 to 120, about 1 to 150, about 1 to 180, about 1 to 200, or about 1 to a greater ratio than 200. The between Uda and alligator pepper is a weight by weight ratio. In some examples 1 to 5 grams of Uda and 1 gram Alligator pepper were extracted in 150 milliliters absolute ethanol. In some examples 0.5 to 50 grams of Uda and 1 gram Alligator pepper were extracted in 150 milliliters absolute ethanol. In some examples more than zero and less than 100 grams of Uda and 1 gram Alligator pepper were extracted in 150 milliliters absolute ethanol. The ratio between uda, alligator pepper and the extracting solvent (i.e. extractant) is a weight (of Uda) per weight (of alligator pepper) per volume (of the extractant) ratio. The Uda: alligator pepper extractant may be from 0.5 to 50 grams Uda: 1 gram alligator pepper: 50-200 milliliters extractant; The Uda: alligator pepper: extractant may be from 0.5 to 20 grams Uda 1 gram alligator pepper: 50-200 milliliters extractant; The Uda: alligator pepper: extractant may be from 0.5 to 10 grams Uda: 1 gram alligator pepper: 50-200 extractant; The Uda: alligator pepper: extractant may be from 0.5 to 5 grams Uda: 1 gram alligator pepper: 50-200 milliliters extractant (i.e. extracting solvent).

The composition or formulation may be tolerated throughout the growth cycle of the mushroom. In some instances, all stages of the mushroom life cycle are not adversely affected by the active ingredient, composition or formulation. The active ingredient, formulation or composition may be biodegradable and non-toxic to humans and animals, even at prolonged or repetitive exposure.

The methods and compositions disclosed herein can be safely used in a variety of environments or locations, For instance, the active ingredient, composition or formulation can be used to reduce, suppress, kill, or prevent, pests such as bacteria, fungi, flies and mosquitoes. The active ingredient, composition or formulation may be effectively used in mushroom farms, greenhouse landfills, homes, hospitals, farms, domestic farms. The composition can also reduce, suppress, eliminate, or prevent odor in an environment. The reduction, suppression, elimination is calibrated relative to a normal (average) human nose. The environment may include an open space, a partially open space or an enclosed space. The environment may include a bodily environment. The bodily environment may include oral, anal, vaginal, axilla (i.e, armpit), folding of the skin, scalp skin, bodily skin. The bodily environment may be of a human or of an animal.

In some embodiments, the formulation can effectively reduce, suppress, kill or prevent pest growth on produces, crops, plants, fruits, vegetables, and mushrooms. For example of pests can be edible mushroom pests, grape pests, or landfill pests.

The methods, systems, active ingredients, formulations and compositions disclosed herein provide for safe and low cost remedies for efficiently reducing, suppressing, killing or preventing one or more pests. The composition comprises extracting at least one active ingredient from at least one past of a plant, e.g. a pepper plant, a Musa plant, a piper plant, a Gongronema plant, or combinations thereof. The one or more active ingredients can be added to a carrier. The composition can be formulated as a spray, a liquid, a cream, a lotion, an elixir, a gel, a paste, an ornament, a chewing gum, or a semi-solid form. When applied in close proximity, the formulation is capable of killing at least one pest. Exemplary pest susceptible to the formulation comprise cecid fly, mycetophils, mites, house fly, horse fly, phorid sciarid fly or spider. In some embodiments, the formulation can effectively reduce, suppress, kill or prevent pests grow on produces, crops, plants, fruits, vegetables, or mushrooms. For example of insects can be edible mushroom pests, grape pests, greenhouse or landfill pests.

The methods and composition provides formulations for efficiently reducing insects, or pests on mushrooms and other edible produces. When in contact with the pest (or in close proximity to the pest) and when the active ingredient is between zero and one parts per billion (ppb) (inclusive weight per weight (w/w)) of the least one active ingredient, the formulation is capable of reducing the insects or pest on mushroom and other edible produces by at least 99.9%, at least 99%, at least 95%, at least 90%, at least 85%, at least 80%, at least 75%, at least 70%, at least 65%, at least 60%, at least 55%, at least 50%, at least 45%, at least 40%, at least 35%, at least 30%, at least 25%, at least 20%, at least 15%, at least 10%, at least 5%, at least 1% or more. When in contact with the pest (or in close proximity to the pest) and when the active ingredient is greater than zero and up to one parts per million (ppm) (w/w) of the least one active ingredient, the fammlation is capable of reducing the insects or pest on mushroom and other edible produces by at least 90% or more. When in contact with the pest (or in close proximity to the pest) and when the active ingredient is greater than zero and up to one part per thousand (wiw) of the least one active ingredient, the formulation is capable of reducing the insects or pest on mushroom and other edible produces by at least 90% or more. When in contact with the pest (or in close proximity to the pest) and when the active ingredient is greater than zero and up to one pans per hundred (w/w) of the least one active ingredient, the formulation is capable of reducing the insects or pest on mushroom and other edible produces by at least 90% or more. When in contact with the pest (or in close proximity to the pest) and when the active ingredient is greater than zero and up to one parts per ten (w/w) of the least one active ingredient, the formulation is capable of reducing the insects or pest on mushroom and other edible produces by at least 90% or more.

In some instances, the pest is affected by the at least one active ingredient when it comes into contact with the at least one active ingredient. The pest the pest can be affected by the at least one active ingredient when it comes into proximity with the active ingredient, with the composition or with the formulation. The proximity can be a proximity of less than or equal to 10 milimeters (mm), less than or equal to 9 mm, less than or equal to 8 mm, less than or equal to 7 mm, less than or equal to 6 mm, less than or equal to 5 mm, less than or equal to 4 mm, less than or equal to 3 mm, less than or equal to 2 mm, less than or equal to 1 mm, less than or equal to 900 micrometers, less than or equal to 800 micrometers, less than or equal to 700 micrometers, less than or equal to 600 micrometers, less than or equal to 500 micrometers, less than or equal to 400 micrometers, less than or equal to 300 micrometers, less than or equal to 200 micrometers, less than or equal to 1.00 micrometers, less than or equal to 90 micrometers, less than or equal to 80 micrometers, less than or equal to 70 micrometers, less than or equal to 60 micrometers, less than or equal to 50 micrometers, less than or equal to 40 micrometers, less than or equal to 30 micrometers, less than or equal to 20 micrometers, less than or equal to 10 micrometers, less than or equal to 9 micrometers, less than or equal to 8 micrometers, less than or equal to 7 micrometers, less than or equal to 6 micrometers, less than o:r equal to 5 micrometers, less than or equal to 4 micrometers, less than or equal to 3 micrometers, less than or equal to 2 micrometers, less than or equal to 1 micrometers, less than or equal to 900 nanometers, less than or equal to 800 nanometers, less than or equal to 700 nanometers, less than or equal to 600 nanometers, less than or equal to 500 nanometers, less than or equal to 400 nanometers, less than o:r equal to 300 nanometers, less than or equal to 200 nanometers, less than or equal to 100 nanometers, loss than or equal to 90 nanometers, less than or equal to 80 nanometers, less than or equal to 70 nanometers, less than or equal to 60 nanometers, less than or equal to 50 nanometers, less than or equal to 40 nanometers, less than or equal to 30 nanometers, less than or equal to 20 nanometers, less than or equal to 10 nanometers, less than or equal to 9 nanometers, less than or equal to 8 nanometers, less than or equal to 7 nanometers, less than or equal to 6 nanometers, less than or equal to 5 nanometers, less than or equal to 4 nanometers, less than or equal to 3 nanometers, less than or equal to 2 nanometers, less than or equal to 1 nanometer.

The methods and composition provides active ingredients, compositions and formulations for efficiently reducing insects, or pests on mushrooms and other edible produces. When in contact with, the insect and when the formulation is greater than zero and up to one ppb (w/w) of the at least one active ingredient, the formulation is capable of reducing the insects or pest on mushroom and other edible produces by more than 1%, more than 5%, more than 10%, more than 15%, more than 20%, more than 25%, more than 30%, more than 35%. more than 40%, more than 45%, more than 50%, more than 60%, more than 65%, more than 70%, more than 75%, more than 80%, more than 85%, more than 90%, more than 95%, more than 99%, or more than 99.9%.

The methods and composition provides formulations for efficiently reducing insects, or pests on mushrooms and other edible produces. When in contact with the insect and when the formulation is greater than zero and up to one ppb (w/w) of the least one active ingredient, the formulation is capable of reducing the insects or pest on mushroom and other edible produces by from 0.1% to 100%, from 1% to 10%, from 5% to 20%, from 10% to 30%, from 15% to 40%, from 20% to 50%, from 30% to 80%, from 40% to 90%, from 50% to 99.9%, from 60% to 85%, or from 70% to 95%.

The systems, methods, active ingredients, formulations and compositions for efficiently reducing pests. When in contact with the pest (on in close proximity to the pest) and when the formulation is greater than zero and up to one ppb (w/w) of the least one active ingredient, the active ingredient, composition or formulation is capable of reducing the insects or pest on mushroom and other edible produces in less than 10 hours, less than 5 hours, less than 2 hours, less than 1 hour (60 seconds), less than 55 seconds, less than 50 seconds, less than 45 seconds, less than 40 seconds, less than 35 seconds, less than 30 seconds, less than 25 seconds, less than 20 seconds, less than 15 seconds, less than 10 seconds, less than 9 seconds, less than 8 seconds, less than 7 seconds, less than 6 seconds, less than 5 seconds, less than 4 seconds, less than 3 seconds, less than 2 seconds, or less than 1 second.

The methods, systems, active ingredients, formulations or composition efficiently reduces the population of at least one pest. When in contact with the pest (or when in dose proximity to the pest) and when the formulation is greater than zero and up to one ppb (w/w) of the least one active ingredient, the formulation is capable of reducing the insects or pest on mushroom and other edible produces within at most 10 hours, at most 5 hours, at most 2 hours, at mostl hour (50 seconds), at most 55 seconds, at most 50 seconds, at most 45 seconds, at most 40 seconds, at most 35 seconds, at most 30 seconds, at most 25 seconds, at most 20 seconds, at most 15 seconds, at most 10 seconds, at most 9 seconds, at most 8 seconds, at most 7 seconds, at most 6 seconds, at most 5 seconds, at most 4 seconds, at most 3 seconds, at most 2 seconds, or at most 1 second.

The methods, systems, active ingredients, formulations or composition efficiently reduces the population of at least one pest. When in contact with the pest (or when in close proximity to the pest) and when the formulation is greater than zero and up to one ppb (w/w) of the least one active ingredient, the formulation is capable of reducing the insects or pest on mushroom and other edible produces within a period from 1 second to 10 seconds, from 1 second to 2 seconds, from 2 seconds to 5 seconds, from 5 seconds to 10 seconds, from 10 seconds to 20 seconds, from 15 seconds to 30 seconds, from 25 seconds to 50 seconds, from 30 seconds to 60 seconds (1 hour), from 1 hour to 5 hours, from 1 hour to 2 hours, from 5 hours to 8 hours, or from 1 hour to 10 hours.

In some embodiments, when in contact (or in close proximity) with the pest and when the formulation is greater than zero and up to one ppb (w/w) of the least one active ingredient, the formulation is capable of reducing the insects or pest on mushroom and other edible produces by at least 90% in less than 60 seconds. In some embodiments, when in contact with the insect and when the tbrmulation is greater than zero and up to one ppb (w/w) of the least one active ingredient, the formulation is capable of reducing the insects or pest on mushroom and other edible produces by at least 90% in less than 2 seconds.

The methods, systems, compositions, active ingredients or formulations disclosed herein for reducing insects or pest that comprises an amount of active ingredient that is greater than zero and up to 10 ppb (w/w) of the at least one active ingredient, greater than zero and up to 20 ppb of the at least one active ingredient, greater than zero and up to 8 ppb of the at least one active ingredient, between 1 and 10 ppb (w/w inclusive) of the at least one active ingredient, or between 1 and 100 ppb (w/w inclusive) of the at least one active ingredient. In some embodiments, the formulation is greater than zero and up to one ppb of the at least one active ingredient.

The methods, systems, compositions, active ingredients or formulations disclosed herein provide for safe and low cost remedies for efficiently reducing, suppressing, killing or preventing one or more bacteria on a subject. The subject may be a human, an animal, a plant, or a mushroom. The composition comprises extracting at least one active ingredient from at least one part of a plant, e.g. a pepper plant, a Musa plant, a piper plant, a Gongronema plant, or combinations thereof. The one or more active ingredients can be added to a carrier. The carrier may be an organic solvent. The carrier may be an extractant. The composition can be formulated as a spray, a liquid, a cream, a lotion, an elixir, a gel, a paste, an ornament, a chewing gum, a semi-solid or a particulate form. When applied in close proximity, the formulation is capable of killing at least one bacterium. The bacteria can be oral bacteria living in the mouth of a subject, bacteria that are related to human odor, or bacteria that are related to acne. In some embodiments, the bacteria susceptible to the disclosed composition is excluded from Proteus mirabilis, Esherichial coli, Staphylococcus aureus, and Candida albicans.

For instance, the active ingredient, composition or formulation can effectively and safely kill at least one oral bacteria. Exemplary of oral bacteria susceptible to the formulation can be selected from the group consisting of Streptococcus mutans, Treponema denticola, Porphyromonas gingivalis Actinobacilus actinomycetemcomitans, Streptococcus sanguis, Streptococcus mutans, Lactobacilli, Actinomyces, Streptococcus mitis, Streptococcus oralis, Streptococcus gordonii, Staphylococcus aureus, Staphylococcus epidermidis, Veillonella, Neisseria sicca, Fusobacterium, Corynebacterium, Prevotella, Actinomyces israelii, Actinomyces naeslundii, Streptococci spirochetes, Treponema denticola Bacteroides Porphyromaonas gingicalis, Actinomyces naeslundii, Spirochetes, Porphyromaonas gingivalis, Spirochetes, Fusiform bacilli, Actinobacillus actinomycetemcomitans, Porphyromaonas gingivalis Fusobacterium nucleatum, Herpes simplex virus, Streptococcus salivarius. Streptococcus gordonii, Streptococcus sobrinus, Candida albicans, Streptococcus mutans, Selenomonas, Actinobacillus actinomycetemcomitans, Porphyromonas gingivalis, Treponema denticola, Prevotella intermedia, Capnocytophaga, Tannerella forsythensis, Porphyromonas endodontalis, Eubacteria, Streptococcus pyogenes, Streptococcus pneumoniae, Haemophilus influenza and Haemophilus parainfluenzae.

As described herein, the methods, systems, active ingredients, formulations or compositions can efficiently reduce the population of one or more oral bacteria on a subject, a human, or an animal. When in contact (or in close pro.xamity) with a bacteria (e.g. oral bacteria) and when the active ingredient is above zero and up to one ppb (waw), the formulation is capable of effectively killing oral bacteria or reducing population of oral bacteria by at least 99.9%, at least 99%, at least 95%, at least 90%, at least 85%, at least 80%, at least 75%, at least 70%, at least 65%, at least 60%, at least 55%, at least 50%, at least 45%, at least 40%, at least 35%, at least 30%, at least 25%, at least 20%, at least 15%, at least 10%, at least 5%, or at least 1% or more.

The methods, systems, active ingredients, formulations or compositions kills, or reduces the population of bacteria. The bacteria may be on a subject, a human, an animal or a plant. When the active ingredient is in contact (or in close proximity) with the bacteria and when the formulation comprises more than zero and up to one ppb (w/w) of the least one active ingredient, the formulation is capable of reducing the bacteria population by more than 1%, more than 5%, more than 10%, more than 15%, more than 20%, more than 25%, more than 30%, more than 35%, more than 40%, more than 45%, more than 50%, more than 60%, more than 65%, more than 70%, more than 75%, more than: 80%, more than 85%, more than 90%, more than 95%, mon than 99%, or mom than 99.9%.

The methods, systems, active ingredients, formulations or compositions is capable of killing, or reducing the population of bacteria. When in contact with the bacteria and when the formulation is above zero and up to one ppb (w/w) of the least one active ingredient, the formulation is capable of reducing the bacteria population in the range of: from 0.1% to 100%, from 1% to 10%, from 5% to 20%, from 10% to 30%, from 15% to 40%, from 20% to 50%, from 30% to 80%, from 40% to 90%, from 50% to 99.9%, from 60% to 85%, or from 70% to 95%.

When in contact with the bacteria and when the formulation is above zero and up to one ppb (w/w) of the least one active inuedient, the formulation is capable of reducing the bacteria population in less than 10 hours, less than 5 hours, less than 2 hours, less than 1 hour (60 seconds), less than 55 seconds, less than 50 seconds, less than 45 seconds, less than 40 seconds, less than 35 seconds, less than 30 seconds, less than 25 seconds, less than 20 seconds, less than 15 seconds, less than 10 seconds, less than 9 seconds, less than 8 seconds, less than 7 seconds, less than 6 seconds, less than 5 seconds, less than 4 seconds, less than 3 seconds, less than 2 seconds, or less than 1 second.

When in contact with the bacteria and when the formulation is above zero and up to one ppb (w/w) of the least: one active ingredient, the formulation is capable of educing the bacteria population in less than 10 hours, less than 5 hours, less than 2 hours, less than 1 hour (60 seconds), less than 55 seconds, less than 50 seconds, less than 45 seconds, less than 40 seconds, less than 35 seconds, less than 30 seconds, less than 25 seconds, less than 20 seconds, less than 15 seconds, less than 10 seconds, less than 9 seconds, less than 8 seconds, less than 7 seconds, less than 6 seconds, less than 5 seconds, less than 4 seconds, less than 3 seconds, less than 2 seconds, or less than 1 second.

When in contact with the bacteria and when the formulation is above zero and up to one ppb (w/w) of the least one active ingredient, the, formulation is capable of reducing the bacteria population within at most 10 hours, at most 5 hours, at most 2 hours, at mostl hour (60 seconds), at most 55 seconds, at most 50 seconds, at most 45 seconds, at most 40 seconds, at most 35 seconds, at most 30 seconds, at most 25 seconds, at most 20 seconds, at most 15 seconds, at most 10 seconds, at most 9 seconds, at most 8 seconds, at most 7 seconds, at most 6 seconds, at most 5 seconds, at most 4 seconds, at most 3 seconds, at most 2 seconds, or at most 1 second.

When in contact with the bacteria and when the formulation is above zero and up to one ppb (w/w) of the least one active ingredient, the formulation is capable of reducing the bacteria population within a period from 1 second to 10 seconds, from 1 second to 2 seconds, from 2 seconds to 5 seconds, from 5 seconds to 1.0 seconds, from 10 seconds to 20 seconds, from 15 seconds to 30 seconds, from 25 seconds to 50 seconds, from 30 seconds to 60 seconds (1 hour), from 1 hour to 5 hours, from 1 hour to 2 hours, from 5 hours to 8 hours, or from 1 hour to 10 hours.

When in contact with the bacteria and when the formulation is above zero and up to one ppb (w/w) of the least one active ingredient, the formulation is capable of reducing the bacteria population by at least 90% within at most 60 seconds. In some embodiments, when in contact with the bacterial and when the formulation is above zero and up to one ppb of the least one active ingredient, the formulation is killing the bacteria or reducing population of the bacteria by at least 90% within at most 10 seconds.

The composition or formulation can comprise above 0 and up to 10 ppb (w/w) of the at least one active ingredient, above 0 and up to 20 ppb (w/w) of the at least one active ingredient, above 0 and up to 8 ppb (w/w) of the at least one active ingredient. above 0 and up to 10 ppb (w/w) of the at least one active ingredient, or between 1 and 100 ppb (w/w; inclusive) of the at least one active ingredient. In some embodiments, the formulation is above 0 up do 1ppb (w/w) ofthe at least one active ingredient.

As another example, the active ingredient, composition, formulation or method can effectively and safely kill at least one bacterium that is related to odor, e.g. human odor. In some embodiments, the human odor can be foot odor, armpit odor, oral odor, vaginal odor, pet odor, or scalp odor. Examples of bacteria related to human odor include but not limited to bacteria from the genus Corynebacteria, Staphylococci, Providencia vermicola, Morganella morgana, Proteus mirabilis, Enterococcus faecalis, microbacterium lactium, or Bacterial indole.

As yet another example, the active ingredient, composition or formulation can effectively and safely kill or reduce the proliferation of at least one bacterium that is related to acne. Typically, the bacteria is from the genus Propionibacterium, e.g., Propionibacterium acnes.

The methods, active ingredient, composition or formulation kiss or reduces the population of one or more acne related bacteria on a subject. When in contact or in close proximity to an acne related bacteria, and when the at least one active ingredient is above zero and up to 20 parts per million (ppm) (w/w), the formulation is capable of effectively killing or reducing the population of acne related bacteria by at least 99.9%, at least 99%, at least 95%, at least 90%, at least 85%, at least 80%, at least 75%, at least 70%, at least 65%, at least 60%, at least 55%, at least 50%, at least 45%, at least 40%, at least 35%, at least 30%, at least 25%, at least 20%, at least 15%, at least 10%, at least 5%, or at least 1%.

When in contact or in close proximity to an acne related bacteria, and when the at least one active ingredient is above zero and up to 20 parts per million (ppm) (w/w), the formulation is capable of effectively killing or reducing the population of acne related bacteria by more than 1%, more than 5%, more than 10%, more than 15%, more than 20%, more than 25%, more than 30%, more than 35%, more than 30%, more than 45%, more than 50%, more than 60%, more than 65%, more than 70%, more than 75%, more than 80%, more than 85%, more than 90%, more than 95%, more than 99%, or more than 99.9%.

When in contact or in close proximity to an acne related bacteria, and when the at least one active ingredient is above zero and up to 20 parts per million (ppm) (w/w), the formulation is capable of effectively killing or reducing the population of acne related bacteria by the cantle of from 0.1% to 100%, from 1% to 10%, from 5% to 20%, from 10% to 30%, from 15% to 40%, from 20% to 50%, from 30% to 80%, from 40% to 90%, from 50% to 99.9%, from 60% to 85%, or from 70% to 95%.

When in contact or in close proximity to an acne related bacteria, and when the at least one active ingredient is above zero and up to 20 parts per million (ppm) (w/w), the formulation is capable of effectively killing or reducing the population of acne related bacteria by at least in less than 10 hours, less than 5 hours, less than 2 hours, less than 1 hour (60 seconds), less than 55 seconds, less than 50 seconds, less than 45 seconds, less than 40 seconds, less than 35 seconds, less than 30 seconds, less than 25 seconds, less than 20 seconds, less than 15 seconds, less than 10 seconds, less than 9 seconds, less than 8 seconds, less than 7 seconds, less than 6 seconds, less than 5 seconds, less than 4 seconds, less than 3 seconds, less than 2 seconds, or less than 1 second.

When in contact or in close proximity to an acne related bacteria, and when the at least one active ingredient is above zero and up to 20 parts per million (ppm) (w/w), the formulation is capable of effectively killing or reducing the population of acne related bacteria within at most 10 hours, within at most 8 hours, within at most 5 hours, within at most 2 hours, within at most 1 hour (60 seconds), within at most 55 seconds, within at most 50 seconds, within at most 45 seconds, within at most 40. seconds, within at most 35 seconds, within at most 30 seconds, within at most 25 seconds, within at most 20 seconds, within at most. 15 seconds, within at most 10 seconds, within at most 9 seconds, within at most 8 seconds, within at most 7 seconds, within at most 6 seconds, within at most 5 seconds, within at most 4 seconds, within at most 3 seconds, within at most 2 seconds, or within at most 1 second.

When icy contact or in close proximity to an acne related bacteria, and when the at least one active ingredient is above zero and up to 20 parts per million (ppm) (w/w), the formulation is capable of effectively killing or reducing the population of acne related bacteria during a period from 1 second to 10 seconds, from 1 second to 2 seconds, from 2 seconds to 5 seconds, from 5 seconds to 10 seconds, from 10 seconds to 20 seconds, from 15 seconds to 30 seconds, from 25 seconds to 50 seconds, from 30 seconds to 60 seconds (1 hour), from 1 hour to 5 hours, from 1 hour to 2 hours, from 5 hours to 8 hours, or from 1 hour to 10 hours.

The active ingredient of the disclosed composition or formulation for killing or reducing the population of oral bacteria, odor associated bacteria, or acne related bacteria can be formulated from above 0 and up to 10 ppm (w/w) of the at least one active ingredient, from above 0 and up to 20 ppm (w/w) of the at least one active ingredient, from above 0 and up to 8 ppm (w/w) of the at least one active ingredient, between 1 and 10 ppm (w/w; inclusive) of the at least one active ingredient, or between 1 and 100 ppm (w/w; inclusive) of the at least one active ingredient. In some embodiments, the formulation is from above 0 and up to 20 ppm (w/w) of the at least one active ingredient. In some embodiments, when in contact with the acne related bacteria and when the formulation is between zero and 20 ppm of the least one active ingredient, the formulation is capable of killing or reducing acne related bacteria by at least 90% within at most 8 hours. In some embodiments, when in contact with the acne related bacteria and when the formulation is between zero and 20 ppm ppb of the least one active ingredient, the tbrinulation is killing or reducing acne related bacteria by at least 90% within at most 10 seconds.

The at least one active ingredient may be used alone or in a formulation for use as an after-shave balm or solution. The at least one active ingredient may be used alone or in a formulation for use as a deodorant, as a shaving cream soap or gel, as a topical cream, as a tooth paste or as a chewing gum. For example, the at least one active ingredient may be formulated with a carrier to from an after-shave balm, and after-shave solution, a topical cream, a lotion, a tooth paste, a deodorant, a tooth paste or a chewing, gum. The balm, lotion or topical cream may comprise oatmeal finely milled oatmeal, colloidal oatmeal, or oatmeal extract). The chewing gum may comprise an elastomer, a resin, a wax, a fat (e.g. oil), an emulsifier, a filler or an antioxidant. The elastomers may comprise natural latex or synthetic rubbers. The natural latex may comprise courna macrocarpa (leche caspi or sorva) or loquat (nispero), tunu, jelutong, or chicle. The synthetic rubbers may comprise styrene-butadiene rubber, butyl rubber or polyisobutylene. The resin may comprise glycerol esters of gum, terpene resin, polyvinyl acetate, or any other resin mentioned herein. The wax may comprise paraffin, microcrystalline wax, beeswax or any other wax mentioned herein. The fat may comprise any fat (i.e. oil) mentioned herein. The emulsifier may comprise lecithin or glycerol monostearate. The filler may comprise calcium carbonate, clay, talc, powdery starch, powdery oat meal or any other organic material mentioned herein. The antioxidant may comprise BHT or any other antioxidant mentioned herein.

Described herein are methods, systems, active ingredients, formulations and compositions for effectively and safely killing or reducing at least one fungus on a subject, a human, a pet, a domestic animal, a plant, or a mushroom. The composition comprises extracting, at least one active ingredient from at least one part of a plant, e.g. a popper plant, a Musa plant, a piper plant, a Gongronema plant, or combinations thereof. The one or more active ingredients can be added to a carrier. In various embodiments, the carrier comprises clay, talc, or powdery starch. In some cases, the composition comprises absorbent. The composition can be formulated as a spray, a liquid, a cream, a lotion, an elixir, a gel, a paste, an ornament, a chewing gum, or a semi-solid form. The carrier may comprise liquid, gel, solid, or semi-solid. The carrier may comprise hydrogel. The carrier may comprise Vaseline resin or wax.

The wax may be animal wax, plant wax, petroleum wax, synthetic wax or any combination thereof. The animal wax may be tallow, beeswax, spermaceti or lanolin. The plant wax may be epicuticular, cuticular wax, or any combination thereof. The plant wax can be carnauba wax, candelilla wax, ouricury wax, soy wax, or a combination thereof. The wax may be petroleum derived wax such as paraffin. A paraffin wax may be comprised of n-alkane having a carbon chain length of at least 10, 15, 20, 25, 30, 35, 40, 45 or 50 carbon atoms and at most 15, 20, 25, 30, 35, 40, 45, 50 or 55 carbon atoms, or any combination of the aforementioned n-alkanes. In some examples, a resin is any component of a liquid that sets into a hard lacquer or enamel-like finish. Resins may comprise natural resins such as amber, kauri gum, rosin, copal, dammar, mastic, sandarac, frankincense, elemi, turpentine, copaiba, ammoniacum, asafoetida, gamboge, myrrh, or scammony. The resin may be derived from a wooden source (a tree, e.g. pine tree). The resin may be a synthetic resin such as nail polish, epoxy resins, thermosetting plastic, or any combination thereof. The gel may be any dilute cross-linked molecular array, which exhibits no flow when in the steady-state. The gel may be hydrogels, xerogels or hydrogels. The gel may be naturally produced, synthetic or any combination thereof. The gel may comprise agarose, methylcellulose, hyaluronan, earagreenan, gelatin, or any combination thereof.

When applied in close proximity, the active ingredient, composition or formulation is capable of killing at least one fungus. The fungus can be from the family Plectosphaereilaceae. In some cases, the fungus is a member of the Arcomycota division. The fungus can be from the genus Verticillium, e.g. Veritcillium fungicola. In some cases, the fungus is a mold selected from the group consisting of the green mold, e.g. Trichoderma spp., Penicillium cycloplium and Aspergillus spp. In some cases, the fungus is a fungus that grows as a pest on an edible mushroom (i.e. edible mushroom fungus), a grape fungus, a landfill fungus, or a green house fungus. The fungus may be a fungus causing athlete's foot disease. The fungus may be Epidermophyton floccosum or fungi of the Trichophyton genus, for example including T. rubrum, T. mentagrophytes, or T. tonsurans. The fungus may be a fungus causing Jock itch. The may be Trichophyton rubrum, Candida albicans, Trichophyton mentagrophytes or Epidermophyton floccosum. The fungus may be of the genus Epidermophyton, Candida or Trichophyton.

Verticillum is a common fungus that grows on edible mushrooms, and can cause considerable damage to the mushroom culture. Verticillium (or fungus spot) that has appeared on an early stage of mushroom development and was not treated in any way, can colonize and destroy the entire crop in a mushrooms growth house.

In some embodiments, the disclosed methods and composition provides safe, efficient and low cost remedies for reducing mushroom fungus, e.g. Verticillium. As an example, the composition can be formulated for fogging in a mushroom house. Depending on the size of the house, for example, a mushroom house of (80 ft×30 ft×15 ft)×1.3 ft can be fogged for three to four hours with the doors and ventilation areas closed. The composition is efficient in killing Verticillium or insects in the room. The room can be subsequently cleaned (e.g. flushed with water). A new crop can be grown after the rinsing and cleaning. The mushroom yield after treatment with the active ingredient, composition or formulation can rise from 0 lb/week to over 50,000 lb/week. In some embodiments, the mushroom yield can be improved by at least 10 times, at least 100 times, at least 1,000 times, at least 10,000 times, least 50,000 times, least 40,000 times, least 30,000 times, least 20,000 times, least 10,000 times, least 5,000 times, at least 1,000 times or more. In some embodiments, the mushroom yield after treatment with the active ingredient, composition or formulation can be improved by at least 100%, at least 90%, at least 80%, at least 70%, at least 60%, at least 50%, at least 45%, at least 40%, at least 35%, at least 30%, at least 20%, at least 10%, at least 5%, at least 1% or more.

In some embodiments, the concentration of the extract may be such that at least 10 gram, at least 20 gram, at least 30 gram, at least 40 gram, at least 50 gram, at least 60 gram, at least 70 gram, at least 80 gram, at least 90 gram, at least 100 gram, at least 110 gram, at least 120 gram, at least 130 gram, at least 140 gram, at least 150 gram, at least 160 gram, at least 170 gram, at least 180 gram, at least 190 gram, 200 gram, at least 210 gram, at least 220 gram, at least 230 gram, at least 240 gram, at least 250 gram, least 260 gram, at least 270 gram, at least 280 gram, at least 290 gram, at least 300 gram, at least 310 gram, at least 320 gram, at least 330 gram, at least 340 gram, at least 350 gram, at least 360 gram, at least 370 gram, at least 380 gram, at least 390 gram, at least 400 gram, at least 410 gram, at least 420 gram, at least 430 gram, at least 440 gram, at least 450 gram, at least 460 gram, at least 470 gram, at least 460 gram, at least 490 gram, at least 500 gram, at least 510 gram, at least 520 gram, at least 530 gram, at least 540 gram, at least 50 gram, at least 560 gram, at least 570 gram, at least 580 gram, at least 590 gram, at least 600 gram, at least 610 gram, at least 620 gram, at least 630 gram, at least 640 gram, at least 650 gram, at least 660 gram, at least 670 gram at least 680 gram, at least 690 gram, at least 700 gram, at least 770 gram, at least 720 gram, at least 730 gram, at least 740 gram, at least 750 gram, at least 760 gram, at least 770 gram, at least 780 gram, at least 790 gram, at least 800 grams, at least 900 gram, at least 910 gram, at least 920 gram, at least 930 gram, at least 940 gram, least 950 gram, at least 960 gram, at least 970 gram, at least 980 gram, or at least 990 gram of plant material (or other bio material) can be extracted in one liter organic solvent. The plant or other bio-material material may be dried plant material or non-dried plant material. The plant material may comprise any plant part. The biological material (i.e. bio material) may comprise any part of the biological material. For example, the plant material may comprise leaves, fruit shell, pods, seeds, stem, bark, flower, fruit or root. The concentration of the extract may be such that at most 10 gram, at most 20 gram, at most 30 gram, at most 40 gram, at most 50 gram, at most 60 gram, at most 70 gram, at most 80 gram, at most 90 gram, at most 100 gram, at most 110 gram, at most 120 gram, at most 130 gram, at most 140 gram, at most 150 gram, at most 160 gram, at most 170 gram, at most 180 gram, at most 190 gram, 200 gram, at most 210 gram, at most 220 gram, at most 230 gram, at most 240 gram, at most 250 gram, at most 260 gram, at most 270 gram, at most 280 gram, at most 290 gram, at most 300 gram, at most 310 gram, at most 320 gram, at most 330 gram, at most 340 gram, at most 350 gram, at most 360 gram, at most 370 gram, at most 380 gram, at most 390 gram, at most 400 gram, at most 410 gram, at most 420 gram, at most 430 gram, at most 440 gram, at most 450 gram, at most 460 gram, at most 470 gram, at most 480 gram, at most 490 gram, at most 500 gram, at most 510 gram, at most 520 gram, at most 530 gram, at most 540 gram at most 550 gram, at most 560 gram, at most 570 gram, at most 580 gram, at most 590 gram, at most 600 gram, at most 610 gram, at most 620 gram, at most 630 gram, at most 640 gram, at most 650 gram, at most 660 gram, at most 670 gram, at most 680 gram, at most 690 gram, at most 700 gram, at most 770 gram, at most 720 gram, at most 730 gram, at most 740 gram, at most 750 gram, at most 760 gram, at most 770 gram, at most 780 gram, at most 790 gram, at most 800 grams, at most 900 gram, at most 910 gram, at most 920 gram, at most 930 gram, at most 940 gram, at most 950 gram, at most 96 gram, at most 970 gram, at most 980 gram, or at most 990 gram of plant or other biological material can be extracted in one liter organic solvent.

In some examples, the amount of plant material (or other bio material) that is extracted in one liter of organic solvent may be from 10 gram to 100 gram, from 70 gram to 120 gram, from 40 gram to 70 gram, from 80 gram to 200 gram, from 250 gram to 400 gram, from 150 gram to 350 gram, from 300 gram to 450 gram, from 400 gram to 650 gram, from 550 gram to 650 gram, from 600 gram to 900 gram, from 10 gram to 1,000 gram of plant or other bio material. The plant or other bio material may be dried. The plant or other bio material may be fresh. The plant or other bio material may be stale. The plant or other bio material may be fermented. The plant or other bio material may be air dried, vacuum dried, freeze dried, oven dried, or any combination thereof.

Optionally, small scale fogging can be applied continuously or intermittently during the growing operation to suppress new pests (e.g. flies) that enter into the mushroom house.

Preferably, the mushroom casing can be treated with the formulation during spot ng operation, Such treatment may be non-toxic, harmless and does not cause adverse effect on the crop.

In some cases, the composition can be formulated in a spreadable fumes, spray, liquid, get, paste. The outdoor formulary can be used for cleaning the outside of the mushroom house, the roof, the floor, and the surrounding areas including cracks in the walls, ground and anywhere the insects may be residing or biding.

In some cases, the methods and compositions can he used to kill or reduce the population of fungus on a subject, e.g. fungus on animals. Examples of animal fungus can include Trichophyton rubrum Trichophyton interdigitale, and Epidennophyton floccosum. The fungus can be a dermatophyte.

As described herein, the methods and compositions can be utilized for reducing animal itching. The methods and compositions comprise extracting at least one active ingredients from at least one part of a plant, e.g. a pepper plant, a Musa plant, a piper plant, a Gongronema plant, or combinations thereof. The one or more active ingredients can be added to a carrier. In various embodiments, the carrier can comprise a fluid. In some cases, the carrier further comprises a colloidal material, an inorganic material, a dye, or a combination thereof. The composition can be formulated as a spray, a liquid, a cream, a lotion, an elixir, a gel, a paste, an ornament, a chewing gum, a semi-solid, or particulate or solid form. When applied to the infected area of a subject, e.g. a human, a pet, a domestic animal, the formulation is capable of reducing the itch. As an example, application of the formulation can reduce fungal infection on the body parts of a subject, e.g. the genitals, the inner thighs, and buttocks. Examples of such disease is jock itch (i.e. eczema marginatum) or athlete's foot (i.e. ringworm of the foot).

The methods, active ingredients, compositions and formulations can be employed to reduce noxious odor of an environment. The methods comprise extracting at least one active ingredient from at least one part of a plant, e.g. a pepper plant, a Musa plant, a piper plant, a Gongronema plant, or combinations thereof. The one or more active ingredients can be added to a carrier, and introducing the formulation to the environment. When applied, the formulation can effectively reduce noxious odor to a level that is not detectable by an average human. For example, the formulation can be used in a farm, a mushroom house, a home, a house, a hospital, a domestic farm, an enclosure, an office building, a vehicle, an airplane, a train, or a boat. The composition or formulation can be formulated in spray or fogging. The composition or formulation can be spreadable on a surface. The composition or fornuilation can be poured on a surface, As a non-limiting example, uda and alligator pepper can he extracted with absolute ethanol. The extract can be filtered and mixed with well water and optionally a biodegradable detergent (e.g. comprising of Citric acid 5-25%+Glycolic acid 2.5-10%+triethanoamine 2.5-10%). The formulation can be applied outdoors or indoors. Other biodegradable surfactants array be incorporated. For example soaps formulated with ashes from biomass. The biomass may be skin of plantain, coconut biomass or palm tree biomass.

In some embodiments, preparation of the formulation for fogging and/or spraying can involve mixing the biomass extract with an aqueous carrier (e.g. water). The formulation may further comprise a detergent. Examples of biomass extracts can be extract of Uda, alligator pepper, musa, utazi, uzazi, or any combinations thereof. In some cases, the ratio of extract to well water is about 1 to 0.01, about 1 to 0.05, about 1 to 0.1, about 1 to 0.2, about 1 to 0.5, about 1 to 1, about 1 to 1.5, about 1 to 2, about 1 to 2.5, about 1 to 3, about 1 to 4, about 1 to 5, about 1 to 6, about 1 to 7, about 1 to 8, about 1 to 9, about 1 to 10, about 1 to 15, about 1 to 20, about 1 to 25, about 1 to 30, about 1 to 40, about 1 to 50, about 1 to 60, about 1 to 70, about 1 to 80, about 1 to 90, about 1 to 100, about 1 to 120, about 1 to 150, about 1 to 180, or about 1 to 200.

In some embodiments, the ratio of extract to detergent is about 1 to 0.01, about 1 to 0.05, about 1 to 0.1, about 1 to 0.2, about 1 to 0.5, about 1 to 1, about 1 to 1.5, about 1 to 2, about 1 to 2.5, about 1 to 3, about 1 to 4, about 1 to 5, about 1 to 6, about 1 to 7, about 1 to 8, about 1 to 9, about 1 to 10, about 1 to 15, about 1 to 20, about 1 to 25, about 1 to 30, about 1 to 40, about 1 to 50, about 1 to 60, about 1 to 70, about 1 to 80, about 1 to 90, about 1 to 100, about 1 to 120, about 1 to 150, about 1 to 180, or about 1 to 200. In some instances the detergent is a surfactant, a soap (e.g. biodegradable soap).

The present disclosure also describes compounds extracted from organic biomass or industrially synthesized for use of reducing population of a least one pest, e.g. human pest, animal pest, plant pest, or mushroom pest. These compounds can he selected from of the group consisting of oxo-phenylethylamine, caryophyllene, alpha-pyrene, beta-pyrene, cyclolanost and gammacerane. The composition can be formulated as a spray, a liquid, a cream, a lotion, an elixir, a gel, a paste, an ornament, a chewing gum, or a semi-solid form. The formulation can effectively kill or deter the proliferation, growth or activity of at least one pest when is applied in close proximity with pest.

The method, active ingredient, formulation or composition of the disclosed composition for killing or reducing population of a pest can be formulated from above 0 to 10 ppb (w/w) of the at least one active ingredient, from above 0 to 20 ppb (w/w) of the at least one active ingredient, from above 0 to 8 ppb (w/w) of the at least one active ingredient, from above 0 to 10 ppb (w/w) of the at least one active ingredient, or from above 0 to 100 ppb (w/w) of the at least one active ingredient. In some embodiments, the formulation is from above 0 to 100 ppb (w/w) of the at least one active ingredient.

When in contact or in close proximity with the pest and at least one active ingredient in the composition or formulation is from above 0 to 1 ppb (w/w), the formulation is capable of effectively killing or reducing population of the pest by at least 99.9%, at least 99%, at least 95%, at least 90%, at least 85%, at least 80%, at least 75%, at least 70%, at least 65%, at least 60%, at least 55%, at least 50%, at least 45%, at least 40%, at least 35%, at least 30%, at least 25%, at least 20%, at least 15%, at least 1.0%, at least 5%, or at least 1%.

When in contact or in close proximity with the pest and when the formulation is formulated from above zero to 1 ppb (w/w) of the least one active ingredient, the formulation is capable of reducing the population of the pest by more than 1%, more than 5%, more than 10%, more than 15%, more than 20%, more than 25%, more than 30%, more than more than 40%, more than 45%, more than 50%, more than 60%, more than 65%, more than 70%, more than 75%, more than 80%, more than 85%, more than 90%, more than 95%, more than 99%, or more than 99.9%.

When in contact or in close proximity with the pest and when the formulation is formulated from above zero to 1 ppb (w/w) of the least one active ingredient, the formulation is capable of reducing the population of the pest in the range of from 0.1% to 100%, from 1% to 10%, from 5% to 20%, from 10% to 30%, from 15% to 40%, from 20% to 50%, from 30% to 80%, from 40% to 90%, from 50% to 99.9%, from 60% to 85%, or from 70% to 95%.

When in contact or in close proximity with the pest and when the formulation is formulated from above zero to 1 ppb (w/w) of the least one active ingredient, the formulation is capable of reducing the population of the pest within less than 10 hours, within less than 5 hours, within less than 2 hours, within less than 1 hour, within less than 10 minutes, within less than 5 minutes, within less than 2 minutes (120 seconds), within less than 1 minute (60 seconds), within less than 55 seconds, within less than 50 seconds, within less than 45 seconds, within less than 40 seconds, within less than 35 seconds, within less than 30 seconds, within less than 25 seconds, within less than 20 seconds, within less than 15 seconds, within less than 10 seconds, within less than 9 seconds, within less than 8 seconds, within less than 7 seconds, within less than 6 seconds, within less than 5 seconds, within less than 4 seconds, within less than 3 seconds, within less than 2 seconds, or within less than 1 second.

When in contact or in close proximity with the pest and when the formulation is formulated from above zero to 1 ppb (wlw) of the least one active ingredient, the formulation is capable of reducing the population of the pest within at most 10 hours, within at most 5 hours, within at most 2 hours, within at most 1 hour (60 seconds), within at most 55 seconds, within at most 50 seconds, within at most 45 seconds, within at most 40 seconds, within at most 35 seconds, within at most 30 seconds, within at most 25 seconds, within at most 20 seconds, within at most 15 seconds, within at most 10 seconds, within at most 9 seconds, within at most 8 seconds, within at most 7 seconds, within at most 6 seconds, within at most 5 seconds, within at most 4 seconds, within at most 3 seconds, within at most 2 seconds, or within at most 1 second.

When in contact or in close proximity with the pest and when the formulation is formulated from above zero to 1 ppb (w/w) of the least one active ingredient, the formulation is capable of reducing the population of the pest within a period from 1 second to 10 seconds, within a period from 1 second to 2 seconds, within a period from 2 seconds to 5 seconds, within a period from 5 seconds to 10 seconds, within a period from 10 seconds to 20 seconds, within a period from 15 seconds to 30 seconds, within a period from 25 seconds to 50 seconds, within a period from 30 seconds to 60 seconds (1 minute), within a period from 1 minute to 2 minutes (120 seconds), within a period from 1 hour to 5 hours, within a period from 1 hour to 2 hours, within a period from 5 hours to 8 hours, or within a period from 1 hour to 10 hours.

When in contact or in close proximity with the pest and when the formulation is formulated from above zero to 1 ppb (w/w) of the least one active ingredient, the formulation is capable of reducing the population of the pest by at least 90% within at most 120 seconds. In some embodiments, when in contact with the pest and when the formulation is between zero and one ppb of the least one active ingredient, the compounds can kill or reduce population of a pest by at least 90% within at most 10 seconds.

The compounds disclosed herein can be extracted from parts of plants including alligator pepper, uda musa plant and Gongronema plant. In some embodiments, the active ingredient is a synthetic ingredient, or an ingredient extracted from another natural or synthetic source. The active ingredient comprises alpha-pyrene or beta-pyrene. The active ingredient comprises an isolated and purified alpha-pyrene or an isolated and purified beta-pyrene found in an organic solvent extract of a plant part. The plant part can come from Aframomum melegueta (alligator pepper). The plant part can come from xylopia aethiopica (uda). The active ingredient may be natural or synthetic caryophyllene. The caryophyllene may be a caryophillene or caryophyllene derivative such as the one found in an organic solvent extract of a Xylopia aethiopica (uda) plant part. The active ingredient may be cyclolanost. The cyclolanost may be cyclolanost or cyclonlanost derivative such as the one found in an organic solvent extract of a musa plant part. The active ingredient may be a gammacerane. The gammacerane may be a gammacerane or a gammacerane derivative such as the one found in an organic solvent extract of a musa plant part. The active ingredient may be synthetic or natural oxo-phenylethylamine. The oxo-phenylethylamine comprises an oxo-derivative such as the one found in an organic solvent extract of a Gongronema latifolium (Utazi) plant part. The phenylethylamine compound can comprise a 2′-(R₁)-oxy-N-(R₂)-2-oxo-2-phonylethylamine. In some cases, R₁ and R₂ can be alkyl chains. In some case, R₁ and R₂ can be branched or linear alkyl chains. In some cases, R₁ and R₂ can be different. In some cases, R₁ and R₂ can be identical. For example, the phenylethylamine can be 2′-methoxy-N-methyl-2-oxo-2-phenylethylamine.

The cyclolanost can be 9,19-cyclolanost-25-en-3-ol or a 9,19-cyclolanost-25-en-3-ol derivative. In some cases, the 9,19-cyclolanost-25-en-3-ol comprises a 24 methyl derivative. In some cases, the 9,19-cyclolanost-25-en-3-ol comprises a 24 ethyl derivative. In some embodiments, the gammacerane can be (C14a)-homo-27-nor-14-beta-gammacerane-3 alpha-ol.

In various embodiments, the composition is formulated to comprise the isolated compounds of plant extracts in combination with an amphiphile, preferrably, an acid amphiphile. In some cases, the acid amphiphilic is a long chain aliphatic amphiphile. The long chain of the aliphatic amphiphile may comprise of 2 carbons, 3 carbons, 4 carbons, 5 carbons, 6 carbons, 7 carbons, 8 carbons, 9 carbons, 10 carbons, 12 carbons, 13 carbons, 14 carbons, 15 carbons, 16 carbons, 17 carbons, 18 carbons, 19 carbons, 20 carbons or more. The organic solvent may a ketone having 1 carbons, 2 carbons, 3 carbons, 4 carbons, 5 carbons, 6 carbons, 7 carbons, 8 carbons, 9 carbons, 10 carbons, 11 carbons, 12 carbons, 13 carbons, 14 carbons, 15 carbons, 16 carbons, 17 carbons, 18 carbons, 19 carbons, 20 carbons, 22 carbons, 23 carbons, 24 carbons, 25 carbons, 26 carbons, 27 carbons, 28 carbons, 29 carbons or more. The long chain may be linear or branched. The composition may also further comprise hexadecanoie acid or a derivative thereof.

Disclosed herein are active ingredients for reducing noxious odor in an environment. These active ingredients can be selected from the group consisting, of oxo-phenylethylamine, caryophyliene, alpha-pyrene, beta-pyrene, cvclolanost and gammacerane. These active ingredients can be selected from the group consisting of aliphatic acid, aliphatic ester, pyrimidil, Kurane, Allopregnan, Copaene, Bicyclo[3.1.1], and Allopregnan. The active ingredients can be extracted from natural or synthetic sources. The active ingredients can be entirely synthetic. The composition or formulation including the active ingredients can be formulated as a spray, a liquid, a cream, a lotion, an elixir, a gel, a paste, an ornament, a chewing gum, or a semi-solid form. When one or more of these active ingredient is added to a carrier and formulated for application, the formulation can effectively reduce noxious odor to an odor level that is not detectable by an average human.

Disclosed herein is a set of compounds capable of reducing the population of at least one pest. The compounds can be selected from the group consisting of aliphatic acid, aliphatic ester, pyrimidil, Kurane, Allopregnan, Copaene, Bicyclo[3.1.1] and Allopregnan. When formulated and applied in contact with the pest or in close proximity to the pest, the formulation is capable of killing or reducing the population of the pest.

The formulation of the disclosed composition for killing or reducing population of a pest can be formulated from above 0 to 10 ppm (w/w) of the at least one active ingredient, from above 0 to 20 ppm (w/w) of the at least one active ingredient, from above 0 to 8 ppm (wiw) of the at least one active ingredient, between 1 and 10 ppm (w/w) of the at least one active ingredient, or between 1 and 100 ppm (w/w; inclusive) of the at least one active ingredient. In some embodiments, the formulation is from above 0 to 20 ppm (w/w) of the at least one active ingredient.

When composition or formulation comprises at least one active ingredient from above 0 to 20 ppm (w/w), and the pest comes in contact or in close proximity to the active ingredient, composition or formulation, the composition or formulation is capable of effectively killing or reducing population of the pest by at least 99.9%, at least 99%, at least 95%, at least 90%, at least 85%, at least 80%, at least 75%, at least 70%, at least 65%, at least 60%, at least 55%, at least 50%, at least 45%, at least 40%, at least 35%, at least 30%, at least 2.5%, at least 20%, at least 15%, at least 10%, at least 5%, or at least 1%.

When composition or formulation comprises at least one active ingredient from above 0 to 20 ppm (w/w), and the pest comes in contact or in close proximity to the active ingredient, composition or formulation, the composition or formulation is capable of effectively killing or reducing population of the pest by more than 1%, more than 5%, more than 10%, more than 15%, more than 20%, more than 25%, more than 30%, more than 35%, more than 40%, more than 35%, more than 50%, more than 60%, more than 65%, more than 70%, more than 75%, more than 80%, more than 85%, more than 90%, more than 95%, more than 99%, or more than 99.9%.

When composition or formulation comprises at least one active ingredient from above 0 to 20 ppm (w/w), and the pest comes in contact or in close proximity to the active ingredient, composition or formulation, the composition or formulation is capable of of killing or reducing population of the pest by in a range of: 0.1% to 100%, from 1% to 10%, from 5% to 20%, from 10% to 30%, from 15% to 40%, from 20% to 50%, from 30% to 80%, from 40% to 90%, from 50% to 99.9%, from 60% to 85%, or from 70% to 95%.

When composition or formulation comprises at least one active ingredient from above 0 to 20. ppm (w/w), and the pest comes in contact or in close proximity to the active ingredient, composition or formulation, the composition or formulation is capable of effectively killing or reducing population of the pest within less than 10 hours, within less than 5 hours, within less than 4 hours, within less than 3 hours, within less than 2 hours, within less than 1 hour, within less than 10 minutes, within less than 5 minutes, within less than 2 minutes (120 seconds), within less than 1 minute (60 seconds), within less than 55 seconds, within less than 50 seconds, within less than 45 seconds, within less than 40 seconds, within less than 35 seconds, within less than 30 seconds, within less than 25 seconds, within less than 20 seconds, within less than 15 seconds, within less than 10 seconds, within less than 9 seconds, within less than 8 seconds, within less than 7 seconds, within less than 6 seconds, within less than 5 seconds, within less than 4 seconds, within less than 3 seconds, within less than 2 seconds, or within less than 1 second.

When composition or formulation comprises at least one active ingredient from above 0 to 20 ppm (w/w), and the pest comes in contact or in close proximity to the active ingredient, composition or formulation, the composition or formulation is capable of effectively or reducing population of the pest within at most 10 hours, within at most 5 hours, within at most 4 hours, within at most 3 hours, within at most 2 hours, within at most 1 hour (60 seconds), within at most 55 seconds, within at most 50 seconds, within at most 45 seconds, within at most 40 seconds, within at most 35 seconds, within at most 30 seconds, within at most 25 seconds, within at most 20 seconds, within at most 15 seconds, within at most 10 seconds, within at most 9 seconds, within at most 8 seconds, within at most 7 seconds, within at most 6 seconds, within at most 5 seconds, within at most 4 seconds, within at most 3 seconds, within at most 2 seconds, or within at most 1 second.

When composition or formulation comprises at least one active ingredient from above 0 to 20 ppm (w/w), and the pest comes in contact or in close proximity to the active ingredient, composition or formulation, the composition or formulation is capable of effectively killing or reducing population of the pest within a period from 1 second to 10 seconds, within a period from 1 second to 2 seconds, within a period from 2 seconds to 5 seconds, within a period from 5 seconds to 10 seconds, within a period from 10 seconds to 20 seconds, within a period from 15 seconds to 30 seconds, within a period from 25 seconds to 50 seconds, within a period from 30 seconds to 60 seconds (1 minute), within a period from 1 minute to 2 minutes (120 seconds), within a period from 1 hour to 5 hours, within a period from 1 hour to 2 hours, within a period from 5 hours to 8 hours, or within a period from 1 hour to 10 hours.

When composition or formulation comprises at least one active ingredient from above 0 to 20 ppm (w/w), and the pest comes in contact or in close proximity to the active ingredient, composition or formulation, the composition or formulation is capable of effectively killing or reducing population of the pest by at least 90% in 4 hours or less.

The active ingredient of the composition or formulation capable of killing or reducing the population of one or more pest may further comprise aliphatic acids such as hexanoic, heptanoic, octanoic, nonanoic, deconoic, undecanoic or dodecanoic; esters such as methyl, ethy, propyl, butyl, pentyl, hexyl, heptyl, octyl, nonyl or octyl ester; or Bicyclo[3.1.1] such as Bicyclo[3.1.1]hept-2-one-2-methanol, 6R₁,6R₂or Bicyclo[3,1.1]hept-3-en-2-one, 4R₁,6R₂,6R₃. In some eases, the R₁,R₂ or R₃ of Bicyclo[3.1.1] can be is selected from the group consisting of methyl, ethyl, propyl, butyl, pentyl, hexyl, heptyl, octyl, nonyl and octyl. The active ingredient may also comprises Allopregan such as Allopregnan-3.alpha.-ol-20-one, and Kaurane such as Kaurane-16-ol, Kaurane-18-ol or Kaurane-16,18-diol. In some embodiments, the pyrimidine comprises Benzenesulfonamide, N-[2-(dimethylamino)-5-pyrimidinyl) or Benzenesulfonamide, N-[2-(diethylamino)-5-pyrimidinyl). In some embodiments, the aliphatic ester is a Methyl ester or ethyl ester of the compound selected from the group consisting of 9,12-Octadecadienoic acid, 10-Octadecanoic acid, Octadecanoic acid, hexadecanoic acid and linoleic acid. The active ingredient may be extracted from a natural source, non-natural source. The active ingredient may be synthetic.

In one aspect, the active ingredient may be isolated and purified from a natural source using an organic solvent such as hexane, ethyl acetate, and/or absolute ethanol (Tables 1 to 9). The plant can be uda, alligator pepper, seed and pod of alligator peppers, utazi, plantain, or banana. Table 10 summarizes the individual compounds (relative to the precursors 1B, 9B, and 8B) unique to different formularies. The results is displayed in the form of a Sparse matrix and Echelon form.

In some cases, mixing uda with alligator pod in hexane and ethyl acetate can result in formation of new compounds, e.g. Bicyclo[3,1.1]hept-2-one-2-methanol, 6,6-dimethyl, Bicyclo[3.1.1]hept-3-en-2-one, 4,6,6-trimethyl, Copaene, Caryophyllene, Hexadecanoic acid, methyl ester, Hexadecanoic acid, ethyl ester, 9,12-Octadecadienoic acid (z,z)-methyl ester, Octadecanoic acid, methyl ester, Linoleic acid ethyl ester, Ethyl Oleate, Octadecanoic acid, ethyl ester, Benzenesulfonamide, N-[2-(dimethylamino)-5-pyrimidinyl), and Kaurane-16,18-diol, (4.beta.) (Table 3).

In another aspect, the compounds isolated and purified from extract of combined and mixed plant parts in solvent such as hexane and ethyl acetate in the presence of catalyst can result in formation of new compounds, e.g. 1H-Naphtho[2.1-b]pyran, 3-ethenyldodecahydro-3,4a,7,7,10a-pentamethyl-. [3R-(3.alpha.,4a.beta.,6a.alpha.,10a.beta.,10b.alpha.)], 10-Octadecanoic acid, methyl ester, Silane, chloroethylmethyl, and Allopregnan-3.alpha.-ol-20-one (Table 4). The plants part can come from an alligator pepper pod and uda.

In some instances, the active ingredients extracted from Uziza leaves comprise Cyclohexane methyl; Heptane 4-methyl, Heptane 2-methyl, Heptane 3-methyl; Heptane 2,2,4-trimethyl; Heptane 2,4-dimethyl; Cyclohexane 1,1,2-trimethyl; 2-Pentanone 4-hydroxy-4-methyl, Cyclohexane 1,2,3-trimethyl, 1,4-Cyclohexadiene 1-methyl-4-(1-methylethyl); Decane; 1,6-Octadien-3-ol 3,7-dimethyl; 1,6,10-dodecatriene 7,11-dimethyl-3-methylene; 1,6,10-dodecatriene-3-ol 3,7,11 trimethyl; Isophytol; 2′-Methoxy-N-methyl-2-oxo-2-phenylethylamine; 2,5-Dimethyl-1-(p-anisyl)pyrrole; Thiabendazole; 4-Nonen-2-yne; Eicosane; Piperine; Dotriaeontane; or Ergost-5-en-3-ol, (3.beta.). 7B=94 grams of dry Uziza leaves extracted with hexane and ethyl acetate.

In some instances, active ingredients extracted from a combination of alligator seed and plantain shell (e,g. 6B) comprise Pentane 2,3,4-trimethyl; 3-Nonen-1-yne; 12-Oxabicyclo[9.1.0]dodeca-3,7-diene, 1,5,5,8-tetramethyl, Ethylene oxide; Phenol 2-methoxy-4-propyl; Benzeneacetic acid 4-hydroxy-3-methoxy methyl ester; Benzeneacetie acid, .alpha.-hydroxy-4-methoxy methyl ester or 4-Pyrimidinamine, 2-methyl-6-(trifluoromethyl), 6B=281 gram dried green plantain shell and alligator (seed and pod) extracted with one liter of hexane and ethyl acetate.

In some embodiments, the active ingredient extracted from green plantain shell (e.g. 5B) comprises Acetic acid 1-methylethyl ester; Pentane 3-ethyl; Pentane 2.3,3-trimethyl; Undecane 2.6-dimethyl; Vitamin E; Stigmasterol; gamma Sitosterol; 1-Naphthalenepropanol .alpha.-ethynyldecahydro-5-(hydroxymethyl); .alpha.,5,8a-trimethyl-2-methylene-[1S-(-(1.alpha.(R@),4a.beta,5.alpha.,8a.alpha)]; Curan-17-oic acid, 2,16-didehydro-20-hydroxy-19-oxo-methyl ester; or Ergost-25-ene-3,5,6,12-tetrol (3.beta.,5.alpha.,6.beta.,12.beta.). 5B=188 gram Dry green plantain shell dried and extracted with one liter of hexane and ethyl acetate.

In some instances, the active ingredient extracted from 4B comprises Bicyclo[3.1.1]hept-2-one-2-methanol 6,6-dimethyl; Bicyclo[3.1.1]hept-3-en-2-one 4,6,6-trimethyl; 1H-Naphtho[2,1-b]pyran 3-ethenyldodecahydro-3,4a,7,7,10a pentamethyl [3R-(3.alpha.,4a.beta.,6a.alpha.,10a.beta.,10b.alpha.)]; Octadecanoic acid ethyl ester, Silane chloroethylmethyl or Allopregnan-3.alpha.-ol-20-one.

In some instances, the active ingredient extracted from a combination of uda and alligator seed and pod with a catalyst (e.g. 4B and 3B with titanium oxide) comprises Tricyclo[2.2.1.02,6]heptane 1,7,7-trimethyl; Bicyclo[3.1.1]hept-3-en-2-one, 4,6,6-trimethyl; 1,2,3,4,5,8-Hexahydronaphthalene; Benzenesulfonic acid 2-nitrohydrazide; Oleic acid; Linoleic acid ethyl ester; Octadecanoic acid ethyl ester; Kaurane-16-ol; 4-Trideeen-6-yne; 19-Hydroxy-13-epimanoyl oxide; Kaurane-18-ol acetate, (4.beta.); Kaurane-18-al 17-(acetyloxy) (4.beta.) or Pregnan-20-one 3-hydroxy (3.beta., 5.alpha.), 3B=300 gram Uda and alligator (both seed and pod) extracted with hexane and ethyl acetate; 4B=375 gram Uda and alligator pod with titanium oxide catalyst extracted with one liter of hexane and ethyl acetate.

In some embodiments, active ingredients extracted from alligator seed, aligator seed and pod and uda (e.g. 1B 8B and 9B) comprise Bicyclo[3.1.1]hept-3-en-2-ol 4,6,6-trimethyl; Cyclopentane, 1-methylene-3-(1-methylethylidene); Copaene; Caryophyllene; Bicyclo[2.2.1]heptane-2,2-dimethyl-3-methylene (1R); Hexadecanoic acid, methyl ester; Hexadecanoic acid, ethyl ester; 9,12-Octadecadienoic acid (z,z)-methyl ester; 6-Octadecenoic acid methyl ester; Linoleic acid ethyl ester; 5.beta.,8.beta.H,9.beta.H,10.alpha.-Labd-14-ene,8,13-epoxy; Ethyl Oleate; Octadecanoic acid, ethyl ester; Octadecanoic acid, ethyl ester; Benzenesulfonamide N-[2-(dimethylamino)-5-pyrimidinyl); L-4-Hydroxy-3-methoxyphenylalanine; Benzeneacetic acid .alpha.-(acetyloxy)-2-methoxy-,methylester; 19-Hydroxy-13-epimanoyl oxide; Kaurane-16,18-diol, (4.beta.); 9-Octadecenoic acid (z)-, 2-hydroxy-1-(hydroxyl methyl) ethyl ester; or Thunbergol. 1B=167 gram alligator seed extracted with hexane and ethyl acetate; 9B=188 gram alligator (both seed and pod) extracted with hexane and ethyl acetate; 8B=188 gram Uda extracted with one liter of hexane and ethyl acetate.

TABLE 1
Alligator pepper seed extracted with hexane and ethyl acetate.

| Compounds | | |
|---|---|---|
| present in | Compounds | |
| A. seed, uda | common to A. | |
| and A. seed + uda | seed and A. | |
| combinations | Seed with pod | 1501275-001B A. Seed (Hexane + Ethyl acetate) |
| | | 1B = 167 gram alligator seed extracted with 1 liter of hexane and ethyl acetate. |
| x | | Butane, 1-ethoxy- (Qual: 91) ~60 mg/L |
| | | Hexane, 3,3,4-trimethyl- (Qual: 78) ~20 mg/L |
| | | Hexane, 2,3,4-trimethyl-(Qial: 86) ~40 mg/L |
| | | Hexane, 2,2,5-trimethyl- (Qual: 59) ~20 mg/L |
| x | | Hexanal (Qual: 72) ~60 mg/L |
| x | | 2-Pentanone, 4-hydroxy-4-methyl- (Qual: 72) ~120 mg/L |
| | x | Acetic acid, 1-methylpropyl ester (Qual: 53) ~50 mg/L |
| | x | 1,6-Octadien-3-ol, 3,7-dimethyl- (Qual: 87) ~30 mg/L |
| | | Bicyclo[7.2.0]undec-4-ene, 4,11,11-trimethyl-8-methylene- (Qual: 86) ~170 mg/L |
| x | | Alpha Caryophyllene (Qual: 96) ~360 mg/L |
| | | Germacrene A (Qual: 62) ~30 mg/L |
| | | 2-Pentadecen-4-yne, (z)- (Qual: 83) ~20 mg/L |
| | x | 2-Butanone, 4-(4-hydroxy-3-methoxyphenyl)- (Qual: 97) ~100 mg/L |
| | | Phenol, 2-undecyl- (Qual: 68) ~10 mg/L |
| | | 3-Decanon, 1-(4-hydroxy-3-methoxyphenyl)- (Qual: 42) ~710 mg/L |
| | x | Benzaldehyde, 2,4-dihydroxy- (Qual: 38) ~60 mg/L |
| | | Benzeneacetic acid, 4-hydroxy-3-methoxyl-, methyl ester (Qual: 35) ~190 mg/L |
| | x | Pyrazine, 2-methoxy-3-(1-methylethyl)- (Qual: 43) ~300 mg/L |
| x | | Gingerol (Qual: 78) ~130 mg/L |
| | | Silane, trimethylphenoxy- (Qual: 25) ~10 mg/L |
| | x | Benzoic acid, 3-(acetylamino)- (Qual: 50) ~20 mg/L |
| | | 9-Octadecenal, (z)- (Qual: 60) ~10 mg/L |
| | x | Secoisolariciresinol (Qual: 53) ~10 mg/L |
| | | 1-Acetoxy-3-phenylthio-2-buranone (Qual: 36) ~10 mg/L |
| | | 2,3-Dihydro-4-methyl-8-nitro-1H-1 ,5-benzodiazepin-2-one (Qual: 27) ~10 mg/L |

A. seed = alligator seed.

TABLE 2
Alligator seed and uda extracted with absolute ethanol.

| Compounds | Compounds | Compounds | | | |
|---|---|---|---|---|---|
| found in | present in | from reaction | | | |
| absolute | A. seed, uda and | between | | | |
| ethanol | A. seed + uda | A. seed and | 1501275-002B A. Seed + Uda | Yield | |
| extraction | combinations | Uda | (Abs. Ethanol Extract) | 002B | |
| | | | 2B = 600 gram Uda and alligator | kg/L | |
| | | | (both seed only) extracted with 1 liter | | |
| | | | of ethanol. | | |
| | x | | Hexanal (Qual: 81) ~60 mg/L | 100 | mg |
| | x | | 2-Pentanone, 4-hydroxy-4-methyl- | 217 | mg |
| | | | (Qual: 36) ~130 mg/L | | |
| | x | | Alpha Pinene (Qual: 97) ~1000 mg/L | 1670 | mg |
| | x | | Beta Pinene (Qual: 78) ~1700 mg/L | 2839 | mg |
| | x | | Benzene, 1-methyl-4-(1- | 84 | mg |
| | | | methylethyl)- (Qual: 95) ~50 mg/L | | |
| x | | | Bicyclo[3.1.1]hept-3-en-2-ol, 4, 6,6- | 418 | mg |
| | | | trimethyl-, (1.alpha.2.alpha.5.alpha.)- | | |
| | | | (Qual: 45) ~250 mg/L | | |
| | x | | Bicyclo[3.3.1]heptan-3-one,6,6- | 150 | mg |
| | | | dimethyl-2-methylene- (Qual: 53) ~90 mg/L | | |
| | | x | Bicyclo[3.1.1]hept-3-en-2-one, 4,6,6- | 134 | mg |
| | | | trimethyl- (Qual: 87) ~80 mg/L | | |
| x | | | Cyclopentane, 1-methylene-3-(1- | 100 | mg |
| | | | methylethylidene)- (Qual: 53) ~60 mg/L | | |
| | | x | Copaene (Qual: 91) ~100 mg/L | 167 | mg |
| | | x | Caryophyllene (Qual: 99) ~100 mg/L | 167 | mg |
| | x | | Alpha Caryophyllene (Qual: 96) ~150 mg/L | 250 | mg |
| x | | | Bicyclo[2.2.1]heptane-2,2-dimethyl- | 200 | mg |
| | | | 3-methylene-, (1R)- (Qual: 80) ~120 mg/L | | |
| | | x | Hexadecanoic acid, methyl ester | 284 | mg |
| | | | (Qual: 99) ~170 mg/L | | |
| | | x | Hexadecanoic acid, ethyl ester (Qual: | 1369 | mg |
| | | | 97) ~820 mg/L | | |
| x | | | 5.beta.,8.beta.H,9.beta,H,10,alpha.h,10.alpha.- | 217 | mg |
| | | | Labd-14-ene,8,13-epoxy- (Qual: 60) ~130 mg/L | | |
| | | x | 9,12-Octadecadienoic acid (z,z)- | 167 | mg |
| | | | methyl ester (Qual: 99) ~100 mg/L | | |
| x | | | 6-Octadecenoic acide, methyl ester | 534 | mg |
| | | | (Z)- (Qual: 99) ~320 mg/L | | |
| | | x | Octadecanoic acid, methyl ester | 84 | mg |
| | | | (Qual: 98) ~50 mg/L | | |
| | x | | Oleic acid (Qual: 99) ~760 mg/L | 1269 | mg |
| | | x | Linoleic acid ethyl ester (Qual: 99) ~510 mg/L | 852 | mg |
| | | x | Ethyl Oleate (Qual: 99) ~840 mg/L | 1403 | mg |
| | | x | Octadecanoic acid, ethyl ester (Qual: | 367 | mg |
| | | | 99) ~220 mg/L | | |
| | | x | Benzenesulfonamide, N-[2- | 468 | mg |
| | | | (dimethylamino)-5-pyrimidinyl)- | | |
| | | | (Qual: 47) ~280 mg/L | | |
| x | | | Benzeneacetic acid, .alpha.- | 1002 | mg |
| | | | (acetyloxy)-2-methoxy-,methylester | | |
| | | | (Qual: 38) ~600 mg/L | | |
| x | | | L-4-Hydroxy-3- | 217 | mg |
| | | | methoxyphenylalanine | | |
| | | | (Qual: 43) ~130 mg/L | | |
| x | | | 19-Hydroxy-13-epimanoyl oxide | 100 | mg |
| | | | (Qual: 25) ~60 mg/L | | |
| | x | | Gingerol (Qual: 93) ~110 mg/L | 184 | mg |
| | x | | 4,25-Secoobscurinervan-4-ol, 22- | 234 | mg |
| | | | ethyl-15,16-dimethoxy-25-acetate, | | |
| | | | (4.beta.,22.alpha)- (Qual: 64) ~140 mg/L | | |
| | x | | Kaur-16-en-l8-oic acid, (4.beta.)- | 755 | mg |
| | | | (Qual: 94) ~440 mg/L | | |
| | | x | Kaurane-16,18-diol, (4.beta.)- (Qual: | 1324 | mg |
| | | | 72) ~80 mg/L | | |
| x | | | 9-Octadecenoic acid (z)-, 2-hydroxy- | 317 | mg |
| | | | 1-(hydroxyl methyl) ethyl ester | | |
| | | | (Qual: 72) ~190 mg/L | | |
| x | | | Thunbergol (Qual: 45) ~760 mg/L | 1269 | mg |

A. seed = alligator seed.

TABLE 3
Alligator seed and pod with uda extracted with hexane and ethyl acetate.

| Compounds | Compounds | | | |
|---|---|---|---|---|
| present in | from reaction | | | |
| A. seed, uda and | between | | | |
| A. seed + uda | A. seed and | | | |
| combinations | Uda | 1501275-003BA. Seed and pod + Uda (Hexane + Ethyl acetate) | Yield 003B | |
| | | 3B = 300 gram Uda and alligator (both seed and pod) | (kg/L) | |
| | | extracted with 1 liter of hexane and ethyl acetate. | | |
| x | | Butane, 1-ethoxy- (Qual: 80) ~50 mg/L relative to 1,4- | 167 | mg |
| | | Dichlorobenzene-d4 | | |
| x | | Pentane, 2,3,3-trimethyl- (Qua1: 83) ~40 mg/L | 133 | mg |
| x | | Hexanal (Qual: 50) ~40 mg/L | 133 | mg |
| x | | 2-Pentanone, 4-hydroxy-4-methyl- (Qual: 50 ~130 mg/L | 433 | mg |
| x | | Alpha Pinene (Qual: 97) ~950 mg/L | 3163 | mg |
| x | | Beta Pinene (Qual: 87) ~1600 mg/L | 5328 | mg |
| x | | Benzene, 1-methyl-4-(1-methylethyl)- (Qual: 97) ~40 mg/L | 133 | mg |
| x | | Limonene (Qual: 93) ~60 mg/L | 200 | mg |
| | | Tricyclo[2.2.1.02,6]heptane, 1,7,7-trimethyl- (Qual″ 87) ~110 mg/L | 336 | mg |
| x | | Bicyclo[3.3.1]heptan-3-one, 6,6-dimethyl-2-methylene- (Qual: 50) ~60 mg/L | 200 | mg |
| | | Bicylo[3.1.1]hept-2-ene-2-Carboxaldehyde, 6,6-dimethyl- (Qual: 86) ~180 mg/L | 599 | mg |
| | x | Bicyclo[3.1.1]hept-3-en-2-one, 4,6,6-trimethyl- (Qual: 64) ~50 mg/L | 167 | mg |
| | | 1,2,3,4,5,8-Hexahydronaphthalene (Qual: 32) ~50 mg/L | 167 | mg |
| | | Benzenesulfonic acid, 2-nitro-,hydrazide (Qual: 90) ~30 mg/L | 100 | mg |
| | x | Copaene (Qual: 99) ~70 mg/L | 233 | mg |
| | x | Caryophyllene (Qual: 95) ~50 mg/L | 167 | mg |
| x | | Hexadecanoic acid (Qual: 98) ~250 mg/L | 832 | mg |
| | | Hexadecanoic acid, ethyl ester (Qual: 95) ~290 mg/L | 966 | mg |
| | | 5.beta.,8.beta.H,9.beta,H,10,alpha.h,10.alpha.-Labd-14- | 266 | mg |
| | | ene,8,13-epoxy- (Qual: 55) ~80 mg/L | | |
| x | | Oleic acid (Qual: 99) ~440 mg/L | 1465 | mg |
| | x | Linoleic acid ethyl ester (Qual: 99) ~150 mg/L | 500 | mg |
| | x | Ethyl Oleate (Qual: 99) ~240 mg/L | 799 | mg |
| | x | Octadecanoic acid, ethyl ester (Qual: 99) ~540 mg/L | 1798 | mg |
| | | 300 g/L | (kg/L) | |
| | x | Benzenesulfonamide, N-[2-(dimethylamino)-5- | 666 | mg |
| | | pyrimidinyl)-(Qual: 50) ~200 mg/L | | |
| | | Kaurane-16-ol (Qual: 91) ~440 mg/L | 1465 | mg |
| | | 4-Tridecen-6-yne, (z)- (Qual: 14) ~100 mg/L | 333 | mg |
| | | 19-Hydroxy-13-epimanoyl oxide (Qual: 25) ~60 mg/L | 200 | mg |
| x | | Gingerol (Qual: 49) ~90 mg/L | 300 | mg |
| x | | 4,25-Secoobscurinervan-4-ol, 22-ethyl-15,16- | 333 | mg |
| | | dimethoxy-25-acetate, (4.beta.,22.alpha)- (Qual: 91) ~100 mg/L | | |
| x | | Kaur-16-en-18-oic acid, (4.beta.)- (Qual: 47) ~320 mg/L | 1067 | mg |
| | | Kaurane-18-ol, acetate, (4.beta.)- (Qual: 25) ~40 mg/L | 133 | mg |
| | | Kaurane-18-al, 17-(acetyloxy)-, (4.beta.)- (Qual: 35) ~50 mg/L | 167 | mg |
| | | 2-Pentadecen-4-yne, (z)- (Qual: 38) ~240 mg/L | 799 | mg |
| | | Pregnan-20-one, 3-hydroxy-, (3.beta.,5.alpha.)- (Qual: 43) ~700 mg/L | 2331 | mg |

A. seed = alligator seed.

TABLE 4
Alligator pod with uda and catalyst extracted with hexane and ethyl alcohol.

| | Compounds | Compounds | | | |
|---|---|---|---|---|---|
| Compounds | present in | from reaction | | | |
| formed with | A. seed, uda and | between | | | |
| presence of | A. seed + uda | A. seed and | 1501275-0048 A. pod + Uda + | Yield | |
| catalyst | combinations | Uda | Catalyst (Hexane and Ethyl alcohol) | 004B | |
| | | | 4B = 375 gram Uda and alligator pod | (kg/L) | |
| | | | with titanium oxide catalyst extracted | | |
| | | | with 1 liter of hexane and ethyl | | |
| | | | acetate. | | |
| | x | | Hexanal (Qual: 64) ~70 mg/L | 187 | mg |
| | x | | 2-Pentanone, 4-hydroxy-4-methyl- | 347 | mg |
| | | | (Qual: 33) ~130 mg/L | | |
| | x | | Alpha Pinene (Qual: 83) ~2000 mg/L | 5340 | mg |
| | x | | Beta Pinene (Qual: 60) ~3600 mg/L | 9612 | mg |
| | x | | Benzene, 1-methyl-2-(1- | 214 | mg |
| | | | methylethyl)- (Qual: 97) ~80 mg/L | | |
| | x | | Limonene (Qual: 93) ~110 mg/L | 294 | mg |
| | x | | Bicyclo[3.3.1]heptan-3-one, 6,6- | 267 | mg |
| | | | dimethyl-2-methylene- (Qual: 56) ~100 mg/L | | |
| | | x | Bicyclo[3.1.1]hept-2-one-2-methanol, | 934 | mg |
| | | | 6,6-dimethyl- (Qual: 59) ~350 mg/L | | |
| | | x | Bicyclo[3.1.1]hept-3-en-2-one, 4,6,6- | 240 | mg |
| | | | trimethyl- (Qual: 87) ~90 mg/L | | |
| | | x | Copaene (Qual: 96) ~130 mg/L | 347 | mg |
| | | x | Caryophyllene (Qual: 95) ~110 mg/L | 294 | mg |
| | x | | Alpha Caryophyllene (Qual: 97) ~130 mg/L | 347 | mg |
| | x | | Cyclohexanemethanol, 4-ethenyl- | 400 | mg |
| | | | .alpha.,.alpha.,4-trimethyl-3-(1- | | |
| | | | methylethenyl)-,[1R- | | |
| | | | (1.alpha.,3.alpha.,4beta)]- (Qual: 62) ~150 mg/L | | |
| | | x | Hexadecanoic acid, methyl ester | 854 | mg |
| | | | (Qual: 99) ~320 mg/L | | |
| | x | | Hexadecanoic acid (Qual: 99) ~680 mg/L | 1816 | mg |
| | | x | Hexadecanoic acid, ethyl ester (Qual: | 4539 | mg |
| | | | 94) ~1700 mg/L | | |
| x | | | 1H-Naphtho[2,1-b]pyran,3- | 481 | mg |
| | | | ethenyldodecahydro-3,4a,7,7,10a- | | |
| | | | pentamethyl-,[3R- | | |
| | | | (3.alpha.,4a.beta.,6a.alpha.,10a.beta., | | |
| | | | 10b.alpha.)]- (Qual: 53) ~180 mg/L | | |
| | | x | 9,12-Octadecadienoic acid (z,z)- | 587 | mg |
| | | | methyl ester (Qual: 99) ~220 mg/L | | |
| x | | | 10-Octadecanoic acid, methyl ester | 1547 | mg |
| | | | (Qual: 99) ~580 mg/L | | |
| | | x | Octadecanoic acid, methyl ester | 214 | mg |
| | | | (Qual: 97) ~80 mg/L | | |
| | x | | Oleic acid (Qual: 99) ~850 mg/L | 2270 | mg |
| | | x | Linoleic acid ethyl ester (Qual: 99) ~1400 mg/L | 3738 | mg |
| | | x | Ethyl Oleate (Qual: 99) ~1800 mg/L | 4806 | mg |
| | | x | Octadecanoic acid, ethyl ester (Qual: | 1121 | mg |
| | | | 97) ~420 mg/L | | |
| | | | 375 g/L | (kg/L) | |
| | | x | Benzenesulfonamide, | 801 | mg |
| | | | N-[2-(dimethylamino)-5-pyrimidinyl)- | | |
| | | | (Qual: 50) ~300 mg/L | | |
| x | | | Silane, chloroethylmethyl- | 481 | mg |
| | | | (Qual: 14) ~180 mg/L | | |
| | x | | Benzeneacetic acid, 4-hydroxy-3- | 400 | mg |
| | | | methoxy-, methyl ester (Qual: 38) ~150 mg/L | | |
| | x | | Gingerol (Qual: 94) ~120 mg/L | 320 | mg |
| | x | | 4,25-Secoobscurinervan-4-ol, 22- | 614 | mg |
| | | | ethyl-15,16-dimethoxy-25-acetate, | | |
| | | | (4.beta.,22.alpha)- (Qual: 81) ~230 mg/L | | |
| | x | | Kaur-16-en-18-oic acid, (4.beta.)- | 1842 | mg |
| | | | (Qual: 64) ~690 mg/L | | |
| | | x | Kaurane-16,18-diol, (4.beta.)- (Qual: | 374 | mg |
| | | | 45) ~140 mg/L | | |
| x | | | Allopregnan-3.alpha.-ol-20-one | 4539 | mg |
| | | | (Qual: 12) ~1700 mg/L | | |

A. seed = alligator seed.

TABLE 5
Dry green plantain extracted with ethyl acetate.

| Compounds | |
|---|---|
| present in | |
| A. seed, uda and | |
| A. seed + uda | |
| combinations | 1501275-005B Cry Green Plantain (Hexane + Ethyl acetate) |
| | 5B = 188 gram Dry green plantain shell dried and extracted with 1 liter of hexane |
| | and ethyl acetate. |
| | Acetic acid, 1-methylethyl ester (Qual: 64) ~910 mg/L |
| x | Butane, 1-ethoxy- (Qual: 91) ~60 mg/L |
| | Pentane, 3-ethyl- (Qual: 78) ~20 mg/L |
| x | Pentane, 2,3,3-trimethyl- (Qual: 78) ~30 mg/L |
| | Undecane, 2,6-dimethyl- (Qual: 50) ~20 mg/L |
| x | 2-Pentanone, 4-hydroxy-4-methyl- (Qual: 38) ~120 mg/L |
| | Vitamin E (Qual: 93) ~8 mg/L |
| | Stigmasterol (Qual: 55) ~10 mg/L |
| | .gamma.-Sitosterol (Qual: 90) ~20 mg/L |
| | 1-Naphthalenepropanol, .alpha.-ethynyldecahydro-5-(hydroxymethyl)-.alpha.,5.8a- |
| | trimethyl-2-methylene-,[1S- |
| | (1.alpha.(R@),4a.beta.,5.alpha.,8a.alpha)- (Qual: 52) ~600 mg/L |
| | Curan-17-oic acid, 2,16-didehydro-20-hydroxy-19-oxo-, methyl ester (Qual: 56) ~630 mg/L |
| | Ergost-25-ene-3,5,6,12-tetrol, (3.beta.,5.alpha.,6.beta.,12.beta.)- (Qual: 38) ~10 mg/L |
| | Caryophyllene (Qual: 55) ~8 mg/L |

A. seed = alligator seed

TABLE 6
Dry green plantain and A. seed with pod extracted with hexane and ethyl acetate.

| Compounds | | | |
|---|---|---|---|
| found in | Compounds | | |
| absolute | present in | Compounds | |
| ethanol extract | seed, uda and | unique to | |
| of A. seed with | seed + uda | A. seed with | 1501275-006B Dry green Plantain + A. Seed |
| pod and uda | combinations | pod | with pod (Hexane + Ethyl acetate) |
| | | | 6B = 281 gram dried green plantain shell and |
| | | | alligator (seed and pod) extracted with 1 liter of |
| | | | hexane and ethyl acetate. |
| | x | | Butane, 1-ethoxy- (Qual: 78) ~60 mg/L |
| x | | | Pentane, 2,3,4-trimethyl- (Qual: 78) ~20 mg/L |
| | x | | Pentane, 2,3,3-trimethyl- (Qual: 59) ~30 mg/L |
| | x | | Hexane, 2,2,4-trimethyl- (Qual: 59) ~20 mg/L |
| | | x | Hexanal (Qual: 53) ~30 mg/L |
| | x | | 2-Pentanone, 4-hydroxy-4-methyl- (Qual: 50) ~10 mg/L |
| | | | Alpha Pinene (Qual: 94) ~20 mg/L |
| | | | Beta Pinene (Qual: 91) ~40 mg/L |
| x | | | Caryophyllene (Qual: 99) ~90 mg/L |
| | | | Alpha Caryophyllene (Qual: 96) ~180 mg/L |
| x | | | 3-Nonen-1-yne, (z)- (Qual: 49) ~10 mg/L |
| x | | | 12-Oxabicyclo[9.1.0]dodeca-3,7-diene,1,5,5,8- |
| | | | tetramethyl-,[1R-(1R@,3E,7E,11R@0]- (Qual: 74) ~10 mg/L |
| x | | | Ethylene oxide (Qual: 4) ~110 mg/L |
| | | | 2-Butanone, 4-(4-hydroxy-3-methoxyphenyl)- |
| | | | (Qual: 95) ~70 mg/L |
| x | | | Benzenesulfonamide, N-[2-(dimethylamino)-5- |
| | | | pyrmidinyl)-(Qual: 50) ~140 mg/L |
| x | | | Phenol, 2-methoxy-4-propyl- (Qual: 32) ~10 mg/L |
| | | | Benzeneacetic acid, 4-hydroxy-3-methoxy-, methyl |
| | | | ester (Qual: 35) ~100 mg/L |
| | | | Pyrazine, 2-methoxy-3-(1-methytethyl)- (Qual: 50) ~120 mg/L |
| | | | Gingerol (Qual: 78) ~90 mg/L |
| | | | Secoisolariciresinol (Qual: 59) ~8 mg/L |
| x | | | Benzeneacetic acid, .alpha.-hydroxy-4-methoxy-, |
| | | | methyl ester (Qual: 50) ~6 mg/L |
| x | | | 4-Pyrimidmamine, 2-methyl-6-(trifluoromethyl)- |
| | | | (Qual: 30) ~8 mg/L |
| | | | Vitamin E (Qual: 83) ~9 mg/L |
| | | | Stigmasterol (Qual: 90) ~10 mg/L |
| x | | | .gamma.-Sitosterol (Qual: 91) ~20 mg/L |
| x | | | 1-Naphthalenepropanol, .alpha.-ethynyldecahydro- |
| | | | 5-(hydroxymethyl)-.alpha.,5.8a-trimethyl-2- |
| | | | methylene-,[1S- |
| | | | (1.alpha.(R@,4a.beta.,5.alpha.,8a.alpha)]- (Qual: 642) ~570 mg/L |
| | | | (Qual: 642) ~570 mg/L |
| x | | | Ergost-25-ene-3,5,6,12-tetrol, |
| | | | (3.beta.,5.alpha.,6.beta.,12.beta.)- (Qual: 25) ~590 |
| | | | mg/L |

TABLE 7
Uziza leaves extract.

| Compounds | |
|---|---|
| found in an | |
| extraction of | |
| A. seed and | |
| uda combined | 1501275-007B Uziza Leaves |
| | 7B = 94 grams of dry Uziza leaves extracted with 1 liter of Ethyl acetate and |
| | Hexane. |
| | Butane, 1-ethoxy- (Qual: 90) ~70 mg/L relative to 1,4-Dichlorobenzene-d4 |
| x | Cyclohexane, methyl- (Qual: 90) ~10 mg/L relative to 1,4-Dichlorobenzene-d4 |
| | Pentane, 2,3,4-trimethyl- (Qual: 86) ~20 mg/L relative to 1,4-Dichlorobenzene-d4 |
| | Heptane, 4-methyl- (Qual: 64) ~30 mg/L relative to 1,4-Dichlorobenzene-d4 |
| x | Heptane, 2-methyl- (Qual: 47) ~7 mg/L relative to 1,4-Dichlorobenzene-d4 |
| x | Heptane, 3-methyl- (Qual: 72) ~7 mg/L relative to 1,4-Dichlorobenzene-d4 |
| x | Heptane, 2,2,4-trimethyl- (Qual: 64) ~20 mg/L relative to 1,4-Dichlorobenzene-d4 |
| x | Heptane, 2,4-dimethyl- (Qual: 72) ~7 mg/L relative to 1,4-Dichlorobenzene-d4 |
| | Cyclohexane, 1,1,2-trimethyl- (Qual: 50) ~8 mg/L relative to 1,4-Dichlorobenzene-d4 |
| | 2-Pentanone, 4-hydroxy-4-methyl- (Qual: 42) ~10 mg/L relative to 1,4- |
| | Dichlorobenzene-d4 |
| x | Cyclohexane, 1,2,3-trimethyl- (Qual: 90) ~6 mg/L relative to 1,4-Dichlorobenzene-d4 |
| x | 1,4-Cyclohexadiene, 1-methyl-4-(1-methylethyl)- (Qual: 83) ~8 mg/L relative to |
| | 1,4-Dichlorobenzne-d4 |
| x | Decane (Qual: 72) ~8 mg/L relative to 1,4-Dichlorobenzene-d4 |
| x | 1,6-Octadien-3-ol, 3,7-dimethyl- (Qual: 76 ~20 mg/L relative to 1,4-Dicholorobenzene-d4 |
| | Caryophyllene (Qual: 98) ~20 mg/L relative to Acenaphthene-d10 |
| | Alpha Caryophyllene (Qual: 91) ~6 mg/L relative to Acenaphthene-d10 |
| x | 1,6,10-dodecatriene, 7,11-dimethyl-3-methylene-.(E)- (Qual: 58) ~30 mg/L relative to Acenaphthene-d10 |
| x | 1,6,10-dodecatriene-3-ol, 3,7,11-trimethyl-[S-(Z)]- (Qual: 91) ~10 mg/L relative to Acenaphthene-d10 |
| x | Isophytol (Qual: 72) ~20 mg/L relative to Acenaphthene-d10 |
| x | 2′-Methoxy-N-methyl-2-oxo-2-phenylthylamine.PFP (Qual: 59) ~90 mg/L relative to Chrysene-d12 |
| x | 2,5-Dimethyl-1-(p-anisyl)pyrrole (Qual: 11) ~10 mg/L relative to Chrysene-d12 |
| x | Thiabendazole (Qual: 11) ~10 mg/L relative to Perylene-d12 |
| x | 4-Nonen-2-yne, (z)- (Qual: 35) ~8 mg/L relative to Perylene-d12 |
| x | Eicosane (Qual: 96) ~9 mg/L relative to Perylene-d12 |
| x | Piperine (Qual: 96) ~20 mg/L relative to Perylene-d12 |
| x | Dotriacontane (Qual: 90) ~10 mg/L relative to Perylene-d12 |
| x | Ergost-5-en-3-ol, (3.beta.)- (Qual: 58) ~10 mg/L relative to Perylene-d12 |
| | .gamma.-Sitosterol (Qual: 89) ~30 mg/L relative to Perylene-d12 |

A. seed = alligator seed.

TABLE 8
Uda extracted with hexane and ethyl acetate.

| Compounds | | | |
|---|---|---|---|
| found in and | | | |
| extract from | | | |
| seed, uda and | | | |
| seed + uda | | | |
| combined | 1501275-008B Uda (Hexane + Ethyl acetate) | Yield 008B | |
| | 8B = 188 gram Uda extracted with 1 liter of hexane and ethyl | kg/L | |
| | acetate. | | |
| | Propane, 1-ethoxy-2-methyl- (Qual: 80) ~70 mg/L | 373 | mg |
| | Hexane, 3-methyl- (Qual: 78) ~20 mg/L relative to 1,4- | 107 | mg |
| | Dichlorobenzene-d4 | | |
| | Hexane, 2,3,4-trimethyl- (Qual: 64) ~30 mg/L | 160 | mg |
| | Hexane, 2,2,5-trimethyl- (Qual: 45) ~20 mg/L | 107 | mg |
| x | Hexanal (Qual: 53) ~40 mg/L | 213 | mg |
| x | 2-Pentanone, 4-hydroxy-4-methyl- (Qual: 40) ~130 mg/L | 693 | mg |
| x | Alpha Pinene (Qual: 94) ~360 mg/L | 1919 | mg |
| | Camphene (Qual: 94) ~20 mg/L | 107 | mg |
| x | Beta Pinene (Qual: 95) ~650 mg/L | 3463 | mg |
| x | Benzene, 1-methyl-4-(1-methylethyl)- (Qual: 97) ~30 mg/L | 160 | mg |
| x | Limonene (Qual: 90) ~20 mg/L | 107 | mg |
| | Eucalyptol (Qual: 94) ~60 mg/L | 320 | mg |
| | 3-Cyclohexen-1-il, 4-methyl-1-(1-methylethyl)- (Qual: 43) ~20 | 107 | mg |
| | mg/L | | |
| | Bicyclo[3.3.1]heptan-2-one, 6,6-dimethyl- (1R)- (Qual: 91) ~30 | 160 | mg |
| | mg/L | | |
| x | Bicyclo[3.3.1]heptan-3-one, 6,6-dimethyl-2-methylene- (Qual: 56) ~70 mg/L | 373 | mg |
| | Bicyclo[3.3.1]hep-2-ene-2-carboxaldehyde, 6,6-dimethy- (Qual: | 693 | mg |
| | 86) ~130 mg/L | | |
| | Bicyclo[3.3.1]heptan-3-en-2-one, 4,6,6-trimethyl- (Qual: 87) ~40 | 213 | mg |
| | mg/L | | |
| | Trans, Trans-nona-2,4-dienol (Qual: 47) ~30 mg/L | 160 | mg |
| x | Cyclohexanemethanol, 4-ethenyl-.alpha.,.alpha.,4-trimethyl-3-(1- | 320 | mg |
| | methylethenyl)-,[1R-(1.alpha.,3.alpha.,4beta)]- (Qual 64) ~60 mg/L | | |
| x | Hexadecanoic acid (Qual: 99) ~440 mg/L | 2345 | mg |
| | 4,5-Nonadiene, 2-methyl- (Qual: 30) ~60 mg/L | 320 | mg |
| | Kauean-16-ene (Qual: 52) ~50 mg/L | 266 | mg |
| | Oleic acid (Qual: 99) ~520 mg/L | 2772 | mg |
| | Octadecanoic acid (Qual: 99) ~50 mg/L | 266 | mg |
| | Cyclohexane, 1,2,4-triethenyl- (Qual: 27) ~20 mg/L | 107 | mg |
| | Kauean-16-ol (Qual: 91) ~150 mg/L | 800 | mg |
| x | 4,25-Secoobscurinervan-4-ol, 22-ethyl-15,16-dimethoxy-25- | 373 | mg |
| | acetate, (4.beta.,22.alpha)- (Qual: 91) ~70 mg/L | | |
| x | Kaur-16-en-l8-oic acid, (4.beta.)- (Qual: 50) ~10 mg/L | 53 | mg |
| | 1-Naphthalenecarboxyllic acid, decahydro-1,-a-dimethyl-6- | 480 | mg |
| | methylene-5-(3-methyl-2,4-pentadienyl)-, methyl ester, [1S- | | |
| | [1.alpha.,4a.alpha.,5.alpha.(E),8a.beta]]- (Qual: 74) ~90 mg/L | | |
| | 5.alpha.-Pregn-16-eb-20-one (Qual: 38) ~350 mg/L | 1866 | mg |
| | 2-Cyclohexen-1-ol, 2-methyl-5-(1-methylethenyl)- (Qual: 52) ~50 mg/L | 266 | mg |
| | Cycloheptane, 1,3,5-tris(methylene)- (Qual: 83) ~20 mg/L | 107 | mg |

TABLE 9
Alligator pepper seed with pod extracted with hexane and ethyl acetate.

| Compounds | | | |
|---|---|---|---|
| present in an | | | |
| extract from a | Compounds | | |
| combination of | common in | | |
| seed, uda and | A. seed and | Compound | 1501275-009B A. Seed with pod |
| seed + uda | A. seed with pod | coming from pod | (Hexane + Ethyl acetate) |
| — | — | — | 9B = 188 gram alligator (both seed and |
| | | | pod) extracted with 1 liter of hexane |
| | | | and ethyl acetate. |
| x | | | Butane, 1-ethoxy- (Qual: 83) ~70 mg/L |
| | | x | Heptane, 4-methyl- (Qual: 83) ~20 mg/L |
| x | | | Pentane, 2,3,3-trimethyl- (Qual: 64) ~30 mg/L |
| | | x | Hexane, 3-ethyl- (Qual: 80) ~7 mg/L |
| | | x | Hexane, 2,2,4-trimethyl- (Qual: 47) ~20 mg/L |
| x | | | Hexanal (Qual: 59) ~50 mg/L |
| | | x | Cyclohexane, 1,1,2-trimethyl- (Qual: 70) ~7 mg/L |
| x | | | 2-Pentanone, 4-hydroxy-4-methyl- (Qual: 50) ~10 mg/L |
| x | | | Alpha Pinene (Qual: 96) ~40 mg/L |
| x | | | Beta Pinene (Qual: 94) ~100 mg/L |
| | | x | Benzene, 1-methyl-3-(1-methylethyl)- (Qual: 95) ~10 mg/L |
| x | | x | D-Limonene (Qual: 90) ~10 mg/L |
| | x | | Acetic acid, 1-methylpropyl ester (Qual: 40) ~50 mg/L |
| | | x | 1,3,6-Octatriene, 3,7-dimethyl- €- |
| | | | (Qual: 94) ~10 mg/L |
| | x | | 1,6-Octadien-3-ol, 3,7-dimethyl- (Qual: |
| | | | 93) ~20 mg/L relative to |
| | | x | Acetic acid, isononyl ester (Qual: 43) ~10 mg/L |
| | | x | 2-Cyclohexen-1-ol, 2-methyl-5-(1- |
| | | | methylethenyl)-, acetate, (1R-cis)- |
| | | | (Qual: 40) ~10 mg/L |
| x | | | Alpha Caryophyllene (Qual: 97) ~400 mg/L |
| | | x | 1,6,10-Dodecatrien-3-ol, 3,7,11- |
| | | | trimethyl- (Qual: 91) ~10 mg/L |
| | x | | 2-Butanone, 4-(4-hydroxy-3- |
| | | | methoxyphenyl)- (Qual: 97) ~90 mg/L |
| x | | x | Hexadecanoic acid (Qual: 99) ~10 mg/L |
| x | | | Benzeneacetic acid, 4-hydroxy-3- |
| | | | methoxy-, methyl ester (Qual: 72) ~6 mg/L |
| x | | x | Oleic acid (Qual: 96) ~20 mg/L |
| | x | | Benzoic acid, 3-(acetylamino)- (Qual: 50) ~30 mg/L |
| | | x | Benzenethanamine, N-trifluoroacetyl-4- |
| | | | hydroxy-3-methoxy- (Qual: 32) ~20 mg/L |
| | | x | Phenol, 4-ethyl-2-methoxy- (Qual: 38) ~230 mg/L |
| | x | | Benzaldehyde, 2,4-dihydroxy- (Qual: 27) ~6 mg/L |
| | x | | Pyrazine, 2-methoxy-3-(1-methylethyl)- |
| | | | (Qual: 47) ~240 mg/L |
| x | | | Gingerol (Qual: 43) ~190 mg/L |
| | | x | 1,2-Benzisothiazole, 3-butoxy- (Qual: 43) ~6 mg/L |
| | x | | Secoisolariciresinol (Qual: 50) ~30 mg/L |
| | | x | Ethyl homovanillate (Qual: 43) ~20 mg/L |
| | | x | 2,3-Dihydro-4-methyl-7-nitro-1H-1,5- |
| | | | benzodiazepin-2-one (Qual: 25) ~20 mg/L |

TABLE 10
Summary of individual compound.

| Extracted Compounds from | | | | | | | | | |
|---|---|---|---|---|---|---|---|---|---|
| Formulation | 1B | 2B | 3B | 4B | 5B | 6B | 7B | 8B | 9B |
| Butane, 1-ethoxy | X | X | X | 0 | X | X | X | 0 | X |
| Hexane, 3,3,4-trimethyl | X | 0 | 0 | 0 | 0 | 0 | 0 | 0 | 0 |
| Hexane, 2,3,4-trimethy | X | 0 | 0 | 0 | 0 | 0 | 0 | X | 0 |
| Hexane, 2,2,5-trimethyl | X | 0 | 0 | 0 | 0 | 0 | 0 | X | 0 |
| Hexanal | X | X | X | X | 0 | X | 0 | X | X |
| 2-Pentanone, 4-hydroxy-4-methyl | X | X | X | X | X | X | X | X | X |
| Acetic acid, 1-methylpropyl ester | X | 0 | 0 | 0 | 0 | 0 | 0 | 0 | X |
| 1,6-Octadien-3-ol, 3,7-dimethyl | X | 0 | 0 | 0 | 0 | 0 | X | 0 | X |
| Bicyclo[7.2.0]undec-4-ene, 4,11,11- | X | 0 | 0 | 0 | 0 | 0 | 0 | 0 | 0 |
| trimethyl-8-methylene | | | | | | | | | |
| Alpha Caryophyllene | X | X | 0 | X | 0 | X | X | 0 | X |
| Germacrene A | X | 0 | 0 | 0 | 0 | 0 | 0 | 0 | 0 |
| 2-Pentadecen-4-yne | X | 0 | X | 0 | 0 | 0 | 0 | 0 | 0 |
| 2-Butanone, 4-(4-hydroxy-3- | X | 0 | 0 | 0 | 0 | X | 0 | 0 | X |
| methoxyphenyl) | | | | | | | | | |
| Phenol, 2-undecyl | X | 0 | 0 | 0 | 0 | 0 | 0 | 0 | 0 |
| 3-Decanon, 1-(4-hydroxy-3- | X | 0 | 0 | 0 | 0 | 0 | 0 | 0 | 0 |
| methoxyphenyl) | | | | | | | | | |
| Benzaldehyde, 2,4-dihydroxy | X | 0 | 0 | 0 | 0 | 0 | 0 | 0 | X |
| Benzeneacetic acid, 4-hydroxy-3- | X | 0 | 0 | X | 0 | X | 0 | 0 | X |
| methoxyl-, methyl ester | | | | | | | | | |
| Pyrazine, 2-methoxy-3- | X | 0 | 0 | 0 | 0 | X | 0 | 0 | X |
| (1-methylethyl) | | | | | | | | | |
| Gingerol | X | X | X | X | 0 | X | 0 | 0 | X |
| Silane, trimethylphenoxy | X | 0 | 0 | 0 | 0 | 0 | 0 | 0 | 0 |
| Benzoic acid, 3-(acetylamino) | X | 0 | 0 | 0 | 0 | 0 | 0 | 0 | X |
| 9-Octadecenal | X | 0 | 0 | 0 | 0 | 0 | 0 | 0 | 0 |
| Secoisolariciresinol | X | 0 | 0 | 0 | 0 | X | 0 | 0 | X |
| 1-Acetoxy-3-phenylthio-2-buranone | X | 0 | 0 | 0 | 0 | 0 | 0 | 0 | 0 |
| 2,3-Dihydro-4-methyl-8- | X | 0 | 0 | 0 | 0 | 0 | 0 | 0 | X |
| nitro-1H-1,5-benzodiazepin-2-one | | | | | | | | | |
| Heptane, 4-methyl | 0 | 0 | 0 | 0 | 0 | 0 | 0 | 0 | X |
| Pentane, 2,3,3-trimethyl | 0 | 0 | X | 0 | X | X | 0 | 0 | X |
| Hexane, 3-ethyl | 0 | 0 | 0 | 0 | 0 | 0 | 0 | 0 | X |
| Hexane, 2,2,4-trimethyl | 0 | 0 | 0 | 0 | 0 | X | 0 | 0 | X |
| Cyclohexane, 1,1,2-trimethyl | 0 | 0 | 0 | 0 | 0 | 0 | X | 0 | X |
| Alpha Pinene | 0 | X | X | X | 0 | X | 0 | X | X |
| Beta Pinene | 0 | X | X | X | 0 | X | 0 | X | X |
| Benzene, 1-methyl-3-(1-methylethyl) | 0 | 0 | X | X | 0 | 0 | 0 | 0 | X |
| D-Limonene | 0 | 0 | 0 | 0 | 0 | 0 | 0 | 0 | X |
| 1,3,6-Octatriene, 3,7-dimethyl | 0 | 0 | 0 | 0 | 0 | 0 | 0 | 0 | X |
| 2-Cyclohexen-1-ol, 2-methyl-5-(1- | 0 | 0 | 0 | 0 | 0 | 0 | 0 | X | X |
| methylethenyl)-, acetate, (1R-cis) | | | | | | | | | |
| 1,6,10-Dodecatrien-3-ol, 3,7,11- | 0 | 0 | 0 | 0 | 0 | 0 | X | 0 | X |
| trimethyl | | | | | | | | | |
| Hexadecanoic acid | 0 | 0 | X | X | 0 | 0 | 0 | X | X |
| Oleic acid | 0 | X | X | X | 0 | 0 | 0 | X | X |
| Benzenethanamine, N-trifluoroacetyl- | 0 | 0 | 0 | 0 | 0 | 0 | 0 | 0 | X |
| 4-hydroxy-3-methoxy | | | | | | | | | |
| Phenol, 4-ethyl-2-methoxy | 0 | 0 | 0 | 0 | 0 | 0 | 0 | 0 | X |
| 1,2-Benzisothiazole, 3-butoxy | 0 | 0 | 0 | 0 | 0 | 0 | 0 | 0 | X |
| Ethyl homovanillate | 0 | 0 | 0 | 0 | 0 | 0 | 0 | 0 | X |
| Propane, 1-ethoxy-2-methyl | 0 | 0 | 0 | 0 | 0 | 0 | 0 | X | 0 |
| Hexane, 3-methyl- | 0 | 0 | 0 | 0 | 0 | 0 | 0 | X | 0 |
| Camphene | 0 | 0 | 0 | 0 | 0 | 0 | 0 | X | 0 |
| Benzene, 1-methyl-4-(1-methylethyl)- | 0 | X | 0 | 0 | 0 | 0 | 0 | X | 0 |
| Limonene | 0 | 0 | 0 | X | 0 | 0 | 0 | X | 0 |
| Eucalyptol | 0 | 0 | O | 0 | 0 | 0 | 0 | X | 0 |
| 3-Cyclohexen-1-il, 4-methyl-1-(1- | 0 | 0 | 0 | 0 | 0 | 0 | 0 | X | 0 |
| methylethyl)- | | | | | | | | | |
| Bicyclo[3.3.1]heptan-2-one, 6,6- | 0 | 0 | | 0 | 0 | 0 | 0 | X | 0 |
| dimethyl- (1R)- | | | | | | | | | |
| Bicyclo[3.3.1]heptan-3-one, 6,6- | 0 | X | X | X | 0 | 0 | 0 | X | 0 |
| dimethyl-2-methylene- | | | | | | | | | |
| Bicyclo[3.3.1]hep-2-ene-2- | 0 | 0 | X | 0 | 0 | 0 | 0 | X | 0 |
| carboxaldehyde, 6,6-dimethyl | | | | | | | | | |
| Bicyclo[3.3.1]heptan-3-en-2-one, | 0 | X | X | X | 0 | 0 | 0 | X | 0 |
| 4,6,6-trimethyl- | | | | | | | | | |
| Trans, Trans-nona-2,4-dienol | 0 | 0 | 0 | 0 | 0 | 0 | 0 | X | 0 |
| Cyclohexanemethanol, 4-ethenyl- | 0 | 0 | 0 | X | O | 0 | 0 | X | 0 |
| .alpha.,.alpha.,4-trimethyl-3- | | | | | | | | | |
| (1-methylethenyl)-,[1R- | | | | | | | 0 | | |
| (1.alpha.,3.alpha.,4beta)] | | | | | | | | | |
| 4,5-Nonadiene, 2-methyl- | 0 | 0 | 0 | 0 | 0 | 0 | 0 | X | 0 |
| Kauean-16-ene | 0 | 0 | 0 | 0 | 0 | 0 | 0 | X | 0 |
| Octadecanoic acid | 0 | 0 | 0 | 0 | 0 | 0 | 0 | X | 0 |
| Cyclohexane, 1,2,4-triethenyl- | 0 | 0 | 0 | 0 | 0 | 0 | 0 | X | 0 |
| Kauean-16-ol | 0 | 0 | 0 | 0 | 0 | 0 | 0 | X | 0 |
| 4,25-Secoobscurinervan-4-ol, 22-ethyl- | 0 | X | X | X | 0 | 0 | 0 | X | 0 |
| 15,16-dimethoxy-25-acetate, | | | | | | | | | |
| (4.beta.,22.alpha)- | | | | | | | | | |
| Kaur-16-en-18-oic acid, (4.beta.)- | 0 | X | X | X | 0 | 0 | 0 | X | 0 |
| 1-Naphthalenecarboxyllic acid, | 0 | 0 | 0 | 0 | 0 | 0 | 0 | X | 0 |
| decahydro-1,4a-dimethyl-6-methylene- | | | | | | | | | |
| 5- | | | | | | | | | |
| (3-methyl-2,4-pentadienyl)-, methyl | | | | | 0 | 0 | 0 | | |
| ester, [1S- | | | | | | | | | |
| [1.alpha.,4a.alpha.,5.alpha.(E),8a.beta]] | 0 | 0 | 0 | 0 | 0 | 0 | 0 | X | 0 |
| 5.alpha.-Pregn-16-eb-20-one | 0 | 0 | 0 | 0 | 0 | 0 | 0 | X | 0 |
| Cycloheptane, 1,3,5-tris(methylene)- | 0 | 0 | 0 | 0 | 0 | 0 | 0 | X | 0 |
| Bicyclo[3.1.1]hept-3-en-2-ol, 4, 6,6- | 0 | X | 0 | 0 | 0 | 0 | 0 | 0 | 0 |
| trimethyl | | | | | | | | | |
| Cyclopentane, 1-methylene-3-(1- | 0 | X | 0 | 0 | 0 | 0 | 0 | 0 | 0 |
| methylethylidene) | | | | | | | | | |
| Copaene | 0 | X | X | X | 0 | 0 | 0 | 0 | 0 |
| Caryophyllene | 0 | X | X | X | X | X | X | 0 | 0 |
| Bicyclo[2.2.1]heptane-2,2-dimethyl-3- | 0 | X | 0 | 0 | 0 | 0 | 0 | 0 | 0 |
| methylene-, (1R) | | | | | | | | | |
| Hexadecanoic acid, methyl ester | 0 | X | 0 | X | 0 | 0 | 0 | 0 | 0 |
| Hexadecanoic acid, ethyl ester | 0 | X | X | X | 0 | 0 | 0 | 0 | 0 |
| 5.beta.,8.beta.H,9.beta,H,10,alpha.h,10.alpha.- | 0 | X | X | 0 | 0 | 0 | 0 | 0 | 0 |
| Labd-14-ene,8,13-epoxy | | | | | | | | | |
| 9,12-Octadecadienoic acid (z,z)-methyl | 0 | X | 0 | X | 0 | 0 | 0 | 0 | 0 |
| ester | | | | | | | | | |
| 6-Octadecenoic acide, methyl ester | 0 | X | 0 | 0 | 0 | 0 | 0 | 0 | 0 |
| Octadecanoic acid, methyl ester | 0 | X | X | X | 0 | 0 | 0 | 0 | 0 |
| Linoleic acid ethyl ester | 0 | X | 0 | X | 0 | 0 | 0 | 0 | 0 |
| Ethyl Oleate | 0 | X | X | X | 0 | 0 | 0 | 0 | 0 |
| Octadecanoic acid, ethyl ester | 0 | X | 0 | X | 0 | 0 | 0 | 0 | 0 |
| Benzenesulfonamide, N-[2- | 0 | X | X | X | 0 | X | 0 | 0 | 0 |
| (dimethylamino)-5-pyrimidinyl) | | | | | | | | | |
| Benzeneacetic acid, .alpha.- | 0 | X | 0 | 0 | 0 | 0 | 0 | 0 | 0 |
| (acetyloxy)-2-methoxy-,methylester | | | | | | | | | |
| L-4-Hydroxy-3-methoxyphenylalanine | 0 | X | 0 | 0 | 0 | 0 | 0 | 0 | 0 |
| 19-Hydroxy-13-epimanoyl oxide | 0 | X | 0 | 0 | 0 | 0 | 0 | 0 | 0 |
| Kaurane-16,18-diol, (4.beta.) | 0 | X | 0 | X | 0 | 0 | 0 | 0 | 0 |
| 9-Octadecenoic acid (z)-, 2-hydroxy-1- | 0 | X | 0 | 0 | 0 | 0 | 0 | 0 | 0 |
| (hydroxyl methyl) ethyl ester | | | | | | | | | |
| Thunbergol | 0 | X | 0 | 0 | 0 | 0 | 0 | 0 | 0 |
| Tricyclo[2.2.1.02,6]heptane, 1,7,7- | 0 | 0 | X | 0 | 0 | 0 | 0 | 0 | 0 |
| trimethyl | | | | | | | | | |
| Bicyclo[3.1.1]hept-3-en-2-one, 4,6,6- | 0 | 0 | X | X | 0 | 0 | 0 | 0 | 0 |
| trimethyl | | | | | | | | | |
| 1,2,3,4,5,8-Hexahydronaphthalene | 0 | 0 | X | 0 | 0 | 0 | 0 | 0 | 0 |
| Benzenesulfonic acid, 2-nitro-, | 0 | 0 | X | 0 | 0 | 0 | 0 | 0 | 0 |
| hydrazide | | | | | | | | | |
| Oleic acid | 0 | 0 | X | X | 0 | 0 | 0 | 0 | 0 |
| Linoleic acid ethyl ester | 0 | 0 | X | X | 0 | 0 | 0 | 0 | 0 |
| Octadecanoic acid, ethyl ester | 0 | 0 | X | X | 0 | 0 | 0 | 0 | 0 |
| Kaurane-16-ol | 0 | 0 | X | 0 | 0 | 0 | 0 | 0 | 0 |
| 4-Tridecen-6-yne, | 0 | 0 | X | 0 | 0 | 0 | 0 | 0 | 0 |
| 19-Hydroxy-13-epimanoyl oxide | 0 | 0 | X | 0 | 0 | 0 | 0 | 0 | 0 |
| Kaurane-18-ol, acetate, (4.beta.) | 0 | 0 | X | 0 | 0 | 0 | 0 | 0 | 0 |
| Kaurane-18-al, 17-(acetyloxy)-, | 0 | 0 | X | 0 | 0 | 0 | 0 | 0 | 0 |
| (4.beta.) | | | | | | | | | |
| Pregnan-20-one, 3-hydroxy-, | 0 | 0 | X | 0 | 0 | 0 | 0 | 0 | 0 |
| (3.beta.,5.alpha.) | | | | | | | | | |
| Bicyclo[3.1.1]hept-2-one-2-methanol, | 0 | 0 | 0 | X | 0 | 0 | 0 | 0 | 0 |
| 6,6-dimethyl | | | | | | | | | |
| Bicyclo[3.1.1]hept-3-en-2-one, 4,6,6- | 0 | 0 | 0 | X | 0 | 0 | 0 | 0 | 0 |
| trimethyl | | | | | | | | | |
| 1H-Naphtho[2,1-b]pyran, 3- | 0 | 0 | 0 | X | 0 | 0 | 0 | 0 | 0 |
| ethenyldodecahydro-3,4a,7,7,10a- | | | | | | | | | |
| pentamethyl-, | | | | | | | | | |
| [3R- | | | | | | | | | |
| (3.alpha.,4a.beta.,6a.alpha.,10a.beta.,10b.alpha.)] | | | | | | | | | |
| Octadecanoic acid, ethyl ester | 0 | 0 | 0 | X | 0 | 0 | 0 | 0 | 0 |
| Silane, chloroethylmethyl | 0 | 0 | 0 | X | 0 | 0 | 0 | 0 | 0 |
| Allopregnan-3.alpha.-ol-20-one | 0 | 0 | 0 | X | 0 | 0 | 0 | 0 | 0 |
| Acetic acid, 1-methylethyl ester | 0 | 0 | 0 | 0 | X | 0 | 0 | 0 | 0 |
| Pentane, 3-ethyl | 0 | 0 | 0 | 0 | X | 0 | 0 | 0 | 0 |
| Pentane, 2,3,3-trimethyl | 0 | 0 | 0 | 0 | X | X | X | 0 | 0 |
| Undecane, 2,6-dimethyl | 0 | 0 | 0 | 0 | X | 0 | 0 | 0 | 0 |
| Vitamin E | 0 | 0 | 0 | 0 | X | X | 0 | 0 | 0 |
| Stigmasterol | 0 | 0 | 0 | 0 | X | X | 0 | 0 | 0 |
| .gamma.-Sitosterol | 0 | 0 | 0 | 0 | X | X | X | 0 | 0 |
| 1-Naphthalenepropanol, .alpha.- | 0 | 0 | 0 | 0 | X | X | 0 | 0 | 0 |
| ethynyldecahydro-5-(hydroxymethyl)- | | | | | | | | | |
| .alpha.,5.8a-trimethyl-2-methylene-, | | | | | | | | | |
| [1S- | | | | | | | | | |
| (1.alpha.(R@),4a.beta.,5.alpha.,8a.alpha)] | | | | | | | | | |
| Curan-17-oic acid, 2,16-didehydro-20- | 0 | 0 | 0 | 0 | X | 0 | 0 | 0 | 0 |
| hydroxy-19-oxo-, methyl ester | | | | | | | | | |
| Ergost-25-ene-3,5,6,12-tetrol, | 0 | 0 | 0 | 0 | X | X | 0 | 0 | 0 |
| (3.beta.,5.alpha.,6.beta.,12.beta.) | | | | | | | | | |
| Pentane, 2,3,4-trimethyl | 0 | 0 | 0 | 0 | 0 | X | X | 0 | 0 |
| 3-Nonen-1-yne, (z) | 0 | 0 | 0 | 0 | 0 | X | 0 | 0 | 0 |
| 12-Oxabicyclo[9.1.0]dodeca-3,7- | 0 | 0 | 0 | 0 | 0 | X | 0 | 0 | 0 |
| diene,1,5,5,8-tetramethyl-,[1R- | | | | | | | | | |
| (1R@,3E,7E,11R@0] | | | | | | | | | |
| Ethylene oxide | 0 | 0 | 0 | 0 | 0 | X | 0 | 0 | 0 |
| Phenol, 2-methoxy-4-propyl | 0 | 0 | 0 | 0 | 0 | X | 0 | 0 | 0 |
| Benzeneacetic acid, 4-hydroxy-3- | 0 | 0 | 0 | 0 | 0 | X | 0 | 0 | 0 |
| methoxy-, methyl ester | | | | | | | | | |
| Benzeneacetic acid, .alpha.-hydroxy-4- | 0 | 0 | 0 | 0 | 0 | X | 0 | 0 | 0 |
| methoxy-, methyl ester | | | | | | | | | |
| 4-Pyrimidinamine, 2-methyl-6- | 0 | 0 | 0 | 0 | 0 | X | 0 | 0 | 0 |
| (trifluoromethyl) | | | | | | | | | |
| Cyclohexane, methyl- | 0 | 0 | 0 | 0 | 0 | 0 | X | 0 | 0 |
| Heptane, 4-methyl- | 0 | 0 | 0 | 0 | 0 | 0 | X | 0 | 0 |
| Heptane, 2-methyl- | 0 | 0 | 0 | 0 | 0 | 0 | X | 0 | 0 |
| Heptane, 3-methyl- | 0 | 0 | 0 | 0 | 0 | 0 | X | 0 | 0 |
| Heptane, 2,2,4-trimethyl- | 0 | 0 | 0 | 0 | 0 | 0 | X | 0 | 0 |
| Heptane, 2,4-dimethyl- | 0 | 0 | 0 | 0 | 0 | 0 | X | 0 | 0 |
| Cyclohexane, 1,1,2-trimethyl- | 0 | 0 | 0 | 0 | 0 | 0 | X | 0 | 0 |
| 2-Pentanone, 4-hydroxy-4-methyl- | 0 | 0 | 0 | 0 | 0 | 0 | X | 0 | 0 |
| Cyclohexane, 1,2,3-trimethyl- | 0 | 0 | 0 | 0 | 0 | 0 | X | 0 | 0 |
| 1,4-Cyclohexadiene, 1-methyl-4-(1- | 0 | 0 | 0 | 0 | 0 | 0 | X | 0 | 0 |
| methylethyl)- | | | | | | | | | |
| Decane | 0 | 0 | 0 | 0 | 0 | 0 | X | 0 | 0 |
| 1,6-Octadien-3-ol, 3,7-dimethyl- | 0 | 0 | 0 | 0 | 0 | 0 | X | 0 | 0 |
| 1,6,10-dodecatriene, 7,11-dimethyl-3- | 0 | 0 | 0 | 0 | 0 | 0 | X | 0 | 0 |
| methylene- | | | | | | | | | |
| 1,6,10-dodecatriene-3-ol, 3,7,11- | 0 | 0 | 0 | 0 | 0 | 0 | X | 0 | 0 |
| trimethyl- | | | | | | | | | |
| Isophytol | 0 | 0 | 0 | 0 | 0 | 0 | X | 0 | 0 |
| 2′-Methoxy-N-methyl-2-oxo-2- | 0 | 0 | 0 | 0 | 0 | 0 | X | 0 | 0 |
| phenylethylamine. | | | | | | | | | |
| 2,5-Dimethyl-1-(p-anisyl)pyrrole | 0 | 0 | 0 | 0 | 0 | 0 | X | 0 | 0 |
| Thiabendazole | 0 | 0 | 0 | 0 | 0 | 0 | X | 0 | 0 |
| 4-Nonen-2-yne, | 0 | 0 | 0 | 0 | 0 | 0 | X | 0 | 0 |
| Eicosane | 0 | 0 | 0 | 0 | 0 | 0 | X | 0 | 0 |
| Piperine | 0 | 0 | 0 | 0 | 0 | 0 | X | 0 | 0 |
| Dotriacontane | 0 | 0 | 0 | 0 | 0 | 0 | X | 0 | 0 |
| Ergost-5-en-3-ol, (3.beta.)- | 0 | 0 | 0 | 0 | 0 | 0 | X | 0 | 0 |

Legend: 1B = 167 gram alligator seed extracted with hexane and ethyl acetate; 2B = 600 gram Uda and alligator (both seed only) extracted with ethanol; 3B = 300 gram Uda and alligator (both seed and pod) extracted with hexane and ethyl acetate; 4B = 375 gram Uda and alligator pod with titanium oxide catalyst extracted with hexane and ethyl acetate; 5B = 188 gram Dry green plantain shell dried and extracted with hexane and ethyl acetate; 6B = 281 gram dried green plantain shell and alligator (seed and pod) extracted with hexane and ethyl acetate; 8B = 188 gram Uda extracted with hexane and ethyl acetate; 7B = 94 grams of dry Uziza leaves extracted with hexane and ethyl acetate; 8B = 188 gram Uda extracted with hexane and ethyl acetate; 9B = 188 gram alligator (both seed and pod) extracted with hexane and ethyl acetate.

The following example is illustrative of one or more embodiments of the present disclosure and is thus non-limiting.

### EXAMPLES

### Example 1

### Natural Ucla is not a fungicide Against Mushroom Verticillium

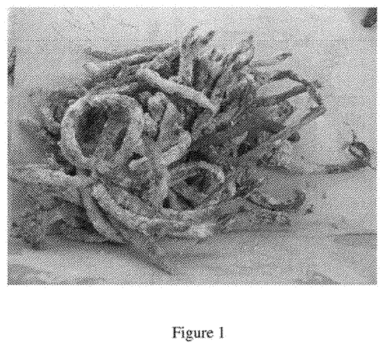

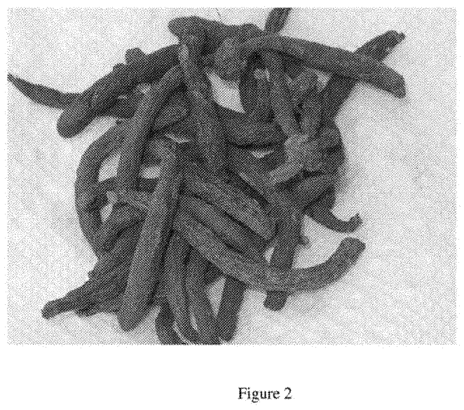

Uda is inoculated with mushroom Verticillium as a control, in comparison with uda inoculated with compositions of the disclosure. FIG. 1 shows fungus showing on uda, while treatment with the composition eliminates fungus from the uda (FIG. 2), suggesting that uda is not a fungicide against mushroom Verticillium.

Extraction of plant parts with ethanol: About 300/L grams of uda and 100/L grams of allegator pepper were milled, blended and soaked ethanol in a container with rubber corks and left for 24 h undisturbed. The reacted precursors was then be filtered off with filter paper (20 micron) into a clean container. One liter of the filtrate mixed with 3 liters of well water for fogging operation using the Hurricane Fogger #2730 Cyclone Bug Insect Stable Lawn Greenhouse.

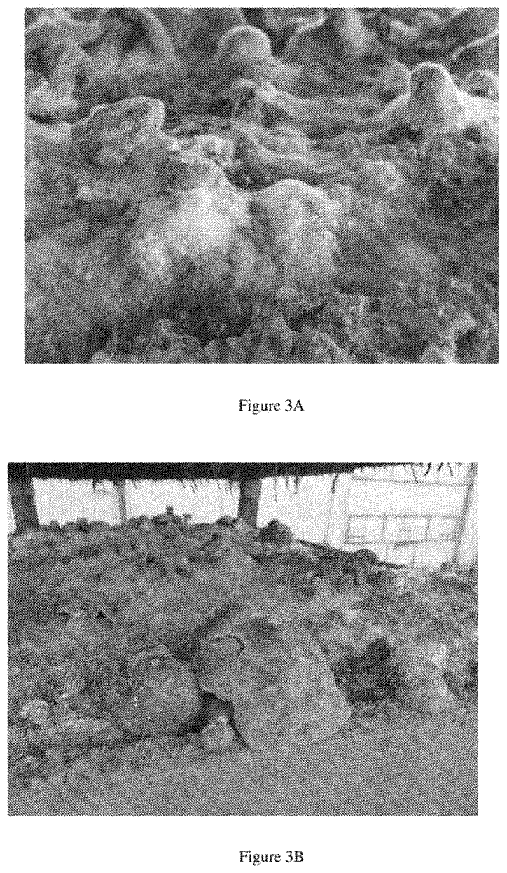

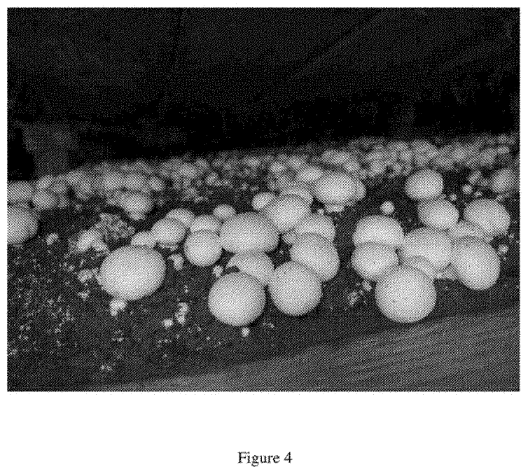

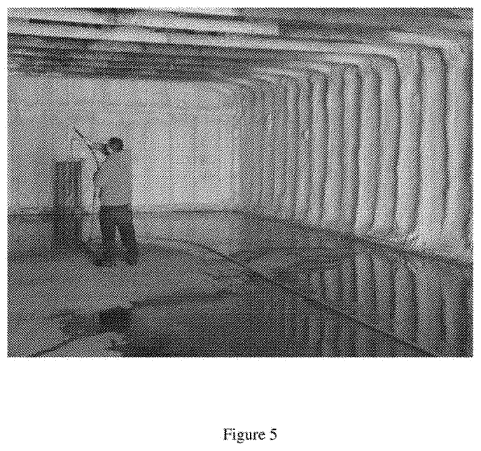

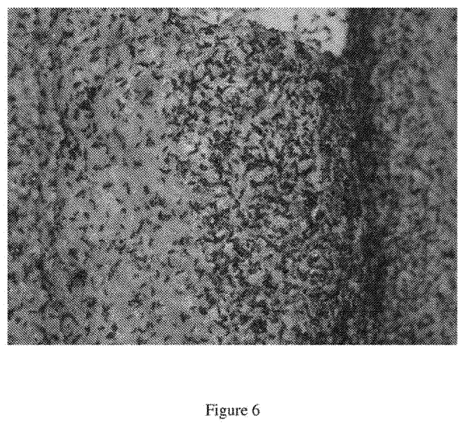

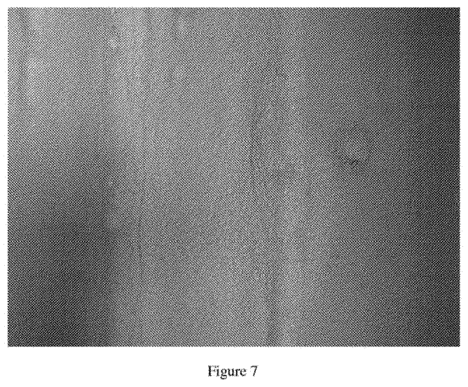

Veriticillium infection causes dries mushroom and fungal infection results in formation of mycelium on the growing mushroom (FIG. 3A). Pest such as flies are attracted to the mushroom (FIG. 3B). Mushrooms are free of insects and fungi after fogging (FIG. 4). The fogging is applied on the walls of the mushroom house (FIG. 5). Insects such as flies are trapped and killed on the fogged mushroom wall after operation (FIG. 6). The wall is then washed and cleaned from dead flies (FIG. 7).

### Example 2

### Identification of Isolated and Purified Active Compounds in Plant Extracts

Plants parts such as uda, alligator seed, alligator pod, and alligator seed with pod, plantain, or banana are used to extract active compounds for killing or reducing pest, insects, and fungi. Extraction of plant parts are described as in Example 1. Compounds identified from different combinations of plant parts, and from different extraction solvent are shown in Tables 1-9. A summary of individual compound unique to the formularies is listed in Table 10.

Example 3: Uda and Alligator pepper seed and pod were soaked in absolute alcohol together and stirred continuously for 24 hours (either manually or with a mechanical or magnetic stirrer). The filtered extract was deployed at a ratio of one part of ethanol extract to 100 parts or water. The formulation containing the extracted active ingredient, water and ethanol was used for internal fogging (i.e. dispersion of the formulation as a vapor) in a growing room with or without growing plants. Similarly, the same procedure was followed for the filtered extract which was deployed at a ratio of one part of ethanol extract to 200 parts or water. Without growing plants the rooms or the premises can be fogged with the addition of 0.5 gal of biodegradable soap to 100 gal of final fogging solution (i.e. extract, ethanol and water as exemplified above).

The preceding merely illustrates the principles of the disclosure. It will he appreciated that those skilled in the art will be able to devise various arrangements which, although not explicitly described or shown herein, embody the principles of the disclosure and are included within its spirit and scope. Furthermore, all examples and conditional language recited herein are principally intended to aid the reader in understanding the principles of the disclosure, and are to be construed as being without limitation to such specifically recited examples and conditions. Moreover, all statements herein reciting principles, cases, and cases of the disclosure as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present disclosure, therefore, is not intended to be limited to the exemplary cases shown and described herein. Rather, the scope and spirit of the present disclosure is embodied by the appended claims.

While preferred cases of the present disclosure have bean shown and described herein, it will be obvious to those skilled in the art that such cases are provided by way of example only. Numerous variations, changes, and substitutions will now occur to those skilled in the art without departing from the disclosure. It should be understood that various alternatives to the cases of the disclosure described herein may be employed in practicing the disclosure. It is intended that the following claims define the scope of the disclosure and that methods and structures within the scope of these claims and their equivalents be covered thereby.

What is claimed is:

1. A method for reducing the population of at least one pest comprising:
forming a formulation by adding a compound selected from the group consisting of oxo-phenylethylamine, caryophyllene, alpha-pyrene, beta-pyrene, cyclolanost and gammacerane;
causing a contact or a close proximity between the pest and the formulation; and
killing the at least one pest when the at least one pest is at least in close proximity with the formulation.

2. The method of claim 1, wherein when the formulation is between zero and one parts per billion (ppb) of the compound, it is able to reduce the population of the at least one pest by at least 90% in 120 seconds or less.

3. The method of claim 1, wherein the alpha-pyrene or beta-pyrene comprises an alpha-pyrene or a beta-pyrene found in an organic solvent extract of an aframomum melegueta (alligator pepper) plant part.

4. The method of claim 1, wherein the alpha-pyrene or beta-pyrene comprises an alpha-pyrene or a beta-pyrene found in an organic solvent extract of a xylopia aethiopica (uda) plant part.

5. The method of claim 1, wherein the caryophyllene comprises a caryophyllene or caryophyllene derivative found in an organic solvent extract of a xylopia aethiopica (uda) plant part.

6. The method of claim 1, wherein the oxo-phenylethylamine comprises an oxo-phenylethylamine found in an organic solvent extract of a Gongronema latifolium (Utazi) plant part.

7. The method of claim 1, wherein the cyclolanost comprises a cyclolanost found in an organic solvent extract of a mesa plant part.

8. The method of claim 1, wherein the gammacerane comprises a gammacerane found in an organic solvent extract of a musa plant part.

9. The method of claim 1, wherein the phenylethylamine comprises a 2′-(R.sub.1)-oxy-N-(R.sub.2)-2-oxo-2-phenylethylamine.

10. The method of claim 2, wherein R.sub.1 and R.sub.2 are alkyl chains.

11. The method of claim 2, wherein the alkyl chains are branched or linear.

12. The method of claim 1, wherein R.sub.1 and R.sub.2 are different.

13. The method of claim 1, wherein R.sub.1 and R.sub.2 are identical.

14. The method of claim 1, wherein the phenylethylamine comprises a 2′-methoxy-N-methyl-2-oxo-2-phenylethylamine.

15. The method of claim 1, wherein the cyclolanost comprises 9,19-cyclolanost-25-en-3-ol or a 9,19-cyclolanost-25-en-3-ol derivative.

16. The method of claim 15, wherein the 9,19-cyclolanost-25-en-3-ol comprises a 24 methyl derivative.

17. The method of claim 15, wherein the 9,19-cyclolanost-25-en-3-ol comprises a 3-beta, 24 ethyl derivative.

18. The method of claim 1, wherein the gammacerane comprises (C14.quadrature.)-homo-27-nor-14-beta-gammacerane-3 alpha-ol.

19. The method of claim 1, further comprising an amplaiphile.

20. The method of claim 1, further comprising hexadecanoic acid.
